(19) United States
(12) Patent Application Publication
(10) Pub. No.: US 2025/0145835 A1
(43) Pub. Date: May 8, 2025

(54) Coating for Reducing Microplastic Shedding in Textile, Coated Textile and Method of Preparing Same

(71) Applicant: The Governing Council of the University of Toronto, Toronto (CA)

(72) Inventors: Kevin Bram GOLOVIN, Toronto (CA); Sudip Kumar LAHIRI, Toronto (CA); Zahra AZIMI DIJVEJIN, Toronto (CA); Weiming LI, Toronto (CA)

(73) Assignee: The Governing Council of the University of Toronto, Toronto (CA)

(21) Appl. No.: 18/934,904

(22) Filed: Nov. 1, 2024

Related U.S. Application Data
(60) Provisional application No. 63/596,001, filed on Nov. 3, 2023.

(30) Foreign Application Priority Data
Jan. 24, 2024 (CA) 3227023

(51) Int. Cl. C09D 5/00; C08K 5/541; C09D 171/02; C09D 183/04; D06M 15/53; D06M 15/643

(52) U.S. Cl. CPC C09D 5/002; C08K 5/541; C09D 171/02; C09D 183/04; D06M 15/53; D06M 15/643

(57) ABSTRACT

The present disclosure provides a textile coating composition comprising a primer bonding to at least one surface of a textile and a polymer brush bonding to the primer. The primer is of general formula (I) and the polymer brush is of general formula (II). A coated textile comprising a textile coated with the textile coating composition and a method of forming the coated textile are also provided.

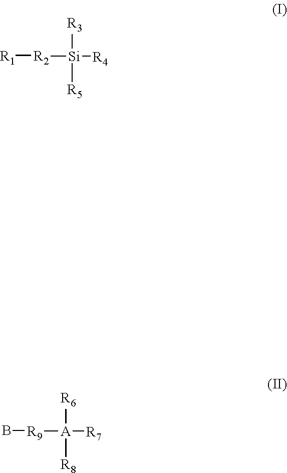

### CROSS REFERENCE TO PRIOR APPLICATIONS

The present application claims priority to U.S. Application No. 63/596,0001 on Nov. 3, 2023 and Canadian Application Number 3,227,023 on Jan. 24, 2024, the entire contents of which are incorporated herein as if set forth in their entirety.

### FIELD OF THE INVENTION

The present disclosure relates to coated textiles and fabrics, and more particularly to a coating composition that can allow a textile or fabric substrate coated with such composition to reduce microplastic shedding upon friction or abrasion. Coated textiles and fabrics capable of reducing microplastic shedding and methods of preparing the same are also disclosed.

### BACKGROUND

This section provides background information related to the present disclosure which is not necessarily prior art.

Microplastic fibres (MPFs), also called microfibres, are major contaminants in oceans, lakes and rivers, and are released by mechanical rubbing, such as friction and abrasion, of textiles during washing and everyday use. For example, our clothes shed several thousand microfibres with every wash, which then enter the water supply, aquatic wildlife and ultimately, human food. Today, the textile industry is focused on improvements in manufacturing processes to lessen eventual microfibre release, but has had limited success. Laundry machine filters are also marketed. However, rather than remediation, there is a need to prevent the release of microplastics from textiles in the first place by acting directly on the textiles themselves.

### SUMMARY

In one aspect, the present disclosure provides a textile coating composition comprising a primer bonding to at least one surface of a textile and a polymer brush bonding to the primer. The primer is of general formula (I), wherein R₁ forms a bond with the at least one surface and is selected from the group consisting of amine, alkoxy, hydroxy, acid, acrylate, halide, ester, ether, alcohol, vinyl, carboxylic, carbonyl, amino, and mercapto; R₂ is selected from the group consisting of alkyl, aryl, siloxane and any combinations thereof; and R₃, R₄ and R₅ are each independently hydroxy, alkoxy optionally substituted with an alkoxy, siloxy, halide or alkyl, with the proviso that R₃, R₄ and R₅ are not simultaneously alkyl. The polymer brush forming a bond with at least one of R₃, R₄ and R₅ of the primer, wherein the polymer brush comprises a polymer having an oxygen-containing backbone and having a glass transition temperature less than about 20° C.

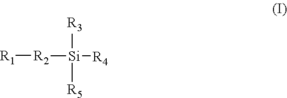

In one aspect, R₁ is an acid, mercapto, amino or vinyl.

In one aspect, R₃, R₄ and R₅ are simultaneously of the same hydroxy, alkoxy optionally substituted with an alkoxy, siloxy, or halide.

In one aspect, the primer is 3-mercaptopropyltrimethoxysilane, 3-mercaptopropyltrichlorosilane, 3-mercaptopropyltriethoxysilane, 3-mercaptopropyldimethylmethoxysilane, 3-mercaptopropyldimethylethoxysilane, 3-mercaptopropyldimethylchlorosilane, 3-mercaptopropyldichloromethylsilane, (3-aminopropyl) triethoxysilane, (3-aminopropyl) trimethoxysilane, (3-aminopropyl) dimethylethoxysilane, (3-aminopropyl) dimethylmethoxysilane, (3-aminopropyl) trichlorosilane, (3-aminopropyl) dichloromethylsilane, (3-aminopropyl) dimethoxymethylsilane, trimethyl (vinyl) silane, vinyl tris(2-methoxyethoxy) silane, methyl bis(trimethylsilyl) vinylsilane, or tris (trimethylsiloxy) (vinyl) silane.

In one aspect, the polymer brush is of general formula (II), wherein A is Si or C; B is the polymer and is selected from the group consisting of poly(dimethylsiloxane), poly(ethylene glycol), polytetrahydrofuran, polyoxetane, pluronic, polyglycerol, polypropyleneglycol, polytetramethylene ether glycol, polybutylene oxide glycol, polypropylene oxide glycol, polidocanol, poly(p-phenylene oxide), perfluoropolyether, polydioxanone and polysiloxane; R₆, R₇ and R₈ are each independently halide, alkoxy, hydroxy or alkyl, with the proviso that at least one of R₆, R₇ and R₈ is halide, alkoxy or hydroxy to form a bond with at least one of R₃, R₄ and R₅, when the at least one of R₃, R₄ and R₅ of the primer is not alkyl; and R₉ is absent or when present, R₉ is a linker comprising at least C1 and is not a repeating unit of the polymer.

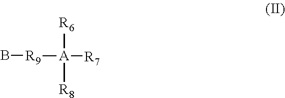

In one aspect, R₇ is hydroxy, halide or alkoxy and forms a bond with each of R₃, R₄ and R₅ when R₃, R₄ and R₅ are all hydroxy.

In one aspect, the polymer is poly(ethylene glycol), perfluoropolyether or poly(dimethylsiloxane).

In one aspect, the polymer has a molecular weight of about 500 to about 100,000.

In one aspect, the polymer is prepared by a silanol polycondensation of a siloxane, silane or silyl ether functionalized monomer in the presence of a Lewis acid catalyst; wherein the monomer is optionally hydrolyzed in the presence of the Lewis acid catalyst. In some embodiments, the Lewis acid catalyst is an acid such as HCI. In some embodiments, the Lewis acid catalyst is a metal catalyst. In some embodiments, the Lewis acid catalyst is a Fe³⁺ catalyst, which includes, but not limited to, Fe(OTf)₃, Fe(OTs)₃ and Fe(2-EH)₃. In one embodiment, the monomer is dimethyldimethoxysilane and the catalyst is Fe(OTs)₃, wherein dimethyldimethoxysilane is hydrolyzed optionally in the presence of Fe(OTs)₃.

In another aspect, the present disclosure provides a coated textile comprising a textile, a primer layer bonding to at least one surface of the textile, and a polymer brush layer overlaying the primer layer, wherein the primer layer comprises a primer as described above and the polymer brush layer comprise a polymer brush as described above.

In one aspect, the coated textile exhibits a friction coefficient of less than about 0.35.

In one aspect, the coated textile is nylon, polyester, acetate, acrylic, spandex, polyolefin, polyaramid, polyethylene, polypropylene, cotton, jute, hemp, bamboo, linen, wool, rayon, silk or any combinations thereof.

In yet another aspect, the present disclosure provides a method of forming a coated textile. The textile includes those as described above. The method comprises depositing a primer layer on a surface of the textile to form a textile surface coated with the primer layer comprising a primer as described above, and depositing a polymer brush layer on the textile surface coated with the primer layer to form the coated textile, wherein the polymer brush layer comprises a polymer brush as described above.

In one aspect, the primer layer is deposited onto the at least one surface of a textile by dipping, padding, spraying, drawing, using an applicator in a gaseous phase, spinning, or using a plasma.

In one aspect, the polymer brush layer is deposited onto the textile surface coated with the primer layer by dipping, padding, spraying, drawing, using an applicator in a gaseous phase, spinning, or using a plasma.

### BRIEF DESCRIPTION OF THE DRAWINGS

The features of certain embodiments will become more apparent in the following detailed description in which reference is made to the appended figures wherein:

FIGS. 1A and 1B (collectively, FIG. 1) schematically show an experiment in accordance with an embodiment of the present disclosure. FIG. 1A: schematic of laboratory-scale fabric laundering process and the filtration of microplastic fibres (MPFs) by analyzing the wash effluent; FIG. 1B: MPFs counting method: (i) Optical image of the nylon mesh filter, (ii) Diagram of the 21 rectangular micrographs (area=Aᵣ) across the filter, and (iii) Diagram of all 121 rectangular micrographs of the filter (expanded counting method) to further validate the reliability of the counting method.

FIGS. 2A to 2D (collectively, FIG. 2) show results of nylon before/after primer-PMDS brush deposition in accordance with an embodiment of the present disclosure. FIG. 2A: schematic of the two-layer coating system developed on the nylon-6,6 fabric surface; FIG. 2B: ATR FTIR spectra of the primer, showing the conversion from neat MPTMS to sulphonic acid functionalized MPTMS; FIG. 2C: ATR FTIR spectra of untreated and primer-PDMS brush treated nylon-6,6 fabric; and FIG. 2D: SEM images of the untreated (i-iii) and treated (iv-vi) nylon-6,6 fabrics at different magnifications.

FIGS. 3A to 3C (collectively, FIG. 3) show results of MPF analysis in accordance with an embodiment of the present disclosure. FIGS. 3A and 3B: SEM images of the filters after laboratory washing of the untreated (FIG. 3A) and primer-PDMS-brush-treated (FIG. 3B) nylon-6,6 fabrics (Scale bars, 1 mm); and FIG. 3C: mean number of MPFs released per gram of fabric from untreated, primer-treated, PDMS-brush-treated and primer-PDMS-brush-treated fabrics. Untreated fabric washed in the presence of fabric softener was also compared (Error bars represent the mean±1 SD and N=3. ***Student's t-test Pvalue<0.005; NS, not significant (P value>0.05)).

FIGS. 4A to 4D (collectively, FIG. 4) show results of fabric analysis before/after washing in accordance with an embodiment of the present disclosure. FIG. 4A: SEM images of (i) prewashed and (ii) postwashed primer-PDMS brush treated nylon-6,6 fabrics; FIG. 4B: ATR FTIR spectra of primer-PDMS brush treated prewashed and postwashed nylon-6,6 fabrics; FIG. 4C: SEM images of (i, ii) untreated and (iii, iv) treated nylon-6,6 fabrics after nine washing cycles; and FIG. 4D: static water contact angles of the untreated and treated nylon-6,6 fabrics as a function of washing cycles. The inserts in FIG. 4C show deposited water droplets before and after washing the fabric. The slight decrease in hydrophobicity of the treated fabric was not statistically significant (p-value: 0.0610), whereas the dramatic decrease for the bare nylon was (p-value: 0.00025).

FIGS. 5A to 5E (collectively, FIG. 5) show effect of primer-PDMS brush finish on friction in accordance with an embodiment of the present disclosure. FIG. 5A: nylon and primer-PDMS brush arrangements evaluated for wet and dry friction measurements using a tribology cell; FIG. 5B: dry friction factor results of the four different sample arrangements during a 4 mm sliding distance. * indicates a Student's t-test p-value<0.05, and **** indicates a Student's t-test p-value<0.001. ns=no significance, i.e. a p-value>0.05, FIG. 5C: the Stribeck curves (wet friction) of bare and primer-PDMS brush coated surfaces using a commercial detergent solution; FIG. 5D: laser scanning profilometer images of bare and primer-PDMS brush coated nylon disc surfaces before and after wet friction tests. The abraded track is labeled as the gap size (all the scale bars were 300 μm); and FIG. 5E: root-mean-squared roughness (S_{q}) and before and after wet friction analysis, for the nylon/nylon and primer-brush/primer-brush interfaces (the results were the average of at least four scans on different areas of the samples). **** indicates a Student's t-test p-value<0.001. ns=no significance, i.e. a p-value>0.05.

FIG. 6 shows dry friction measurements of nylon/nylon and primer-brush/nylon samples in accordance with an embodiment of the present disclosure.

FIGS. 7A and 7B (collectively, FIG. 7) show results of bending test in accordance with an embodiment of the present disclosure. FIG. 7A: schematic diagram of bending test according to the BS 3356-1990 standard; and FIG. 7B: bending rigidity of untreated and primer-PDMS brush treated nylon-6,6 fabrics. ns=no significance (p-value>0.05). Error bars are the mean±1 SD and N=5.

FIG. 8 shows results of permeability test of the untreated and primer-PDMS brush treated nylon-6,6 fabrics, according to ASTM D737-96 standard, in accordance with an embodiment of the present disclosure. ns=no significance (p-value>0.05). Error bars are the mean±1 SD and N=5.

FIG. 9 shows the mean number of MPFs per gram of fabric released from untreated and primer-PDMS brush treated fabrics as a function of washing conditions, in accordance with an embodiment of the present disclosure. Error bars are the mean±1 SD and N=3. * indicates a Student's t-test p-value<0.05, ** indicates a Student's t-test p-value<0.01, and ns=no significance (p-value>0.05).

FIG. 10 shows the mean number of MPFs per gram of fabric released from untreated and primer-PDMS brush treated fabrics, plotted against different washing times, in accordance with an embodiment of the present disclosure. Error bars are the mean±1 SD and N=3.

FIG. 11 shows static water contact angles of the untreated and primer-PDMS brush treated nylon-6,6 fabrics as a function of the number of washing cycles, in accordance with an embodiment of the present disclosure. The schematic inserts show deposited water droplets before and after washing the fabrics. Error bars are the mean±1 SD and N=3.

FIG. 12 shows static water contact angles of the untreated and primer-PDMS treated nylon fabrics as a function of washing conditions, in accordance with an embodiment of the present disclosure. Error bars are the mean±1 SD and N=3. *** indicates a Student's t-test p-value<0.001 and ns=no significance (p-value>0.05).

FIG. 13 shows results from handwashing of bare polyester and polyester treated in accordance with an embodiment of the present disclosure.

FIG. 14 depicts a modified fabric washing method that allows a uniform washing of coated and uncoated fabrics in accordance with an embodiment of the present disclosure.

FIGS. 15A and 15B (collectively, FIG. 15) show results from a study of washing coated and uncoated fabrics together in accordance with an embodiment of the present disclosure. FIG. 15A shows the amount of MPFs released per gram of fabric after two uncoated fabrics were washed together. FIG. 15B shows the amount of MPFs released per gram of fabric when the bottom fabric was coated with an exemplary primer-polymer brush coating and the other fabric remained uncoated.

FIG. 16 shows results from a study to investigate the extent of reduction of MPFs released into the air when dry coated fabrics were rubbed against each other, in accordance with an embodiment of the present disclosure.

FIGS. 17A to 17D (collectively, FIG. 17) show results of dry abrasion tests in accordance with an embodiment of the present disclosure. FIG. 17A shows the amount of MPFs released from one-sided fleece fabrics in separate dry abrasion cycles; FIG. 17B shows the total amount of MPFs released from the one-sided fleece fabrics during dry abrasion conditions; FIG. 17C shows the amount of MPFs released from double-sided fleece fabrics in separate dry abrasion cycles; and FIG. 17D shows the total amount of MPFs released from the double-sided fleece fabrics during dry abrasion conditions.

FIGS. 18A to 18D (collectively, FIG. 18) show results of wet abrasion tests in accordance with an embodiment of the present disclosure. FIG. 18A shows the amount of MPFs released from one-sided fleece fabrics in separate wet abrasion cycles; FIG. 18B shows the total amount of MPFs released from the one-sided fleece fabrics during wet abrasion conditions; FIG. 18C shows the amount of MPFs released from double-sided fleece fabrics in separate wet abrasion cycles; and FIG. 18D shows the total amount of MPFs released from the double-sided fleece fabrics during wet abrasion conditions.

### DETAILED DESCRIPTION

The average size of microplastics is between 11 μm and 5,000 μm, and those less than 500 μm in length are generally considered microplastic fibres (“MPFs”). For the purpose of this disclosure, the terms “microplastic”, “microplastic fibre” and “microfibre” are used interchangeably unless indicated otherwise.

The term “textile” or “textile substrate” as used herein refer to any textile material suitable for use as a substrate in connection with the coatings and/or methods of the present disclosure. As would be understood by a person skilled in the art, textiles are made from fibres that are natural, synthetic or a combination of both and can encompass fibres, yarns, filaments, threads, fabrics and cloths. The terms “textile”, “fabric” and “cloth”, alone or with other terms used herein, are used interchangeably in the context of the present disclosure, unless otherwise indicated.

The terms “treated textile,” “coated textile substrate,” “treated textile substrate,” and “coated textile substrate” are generally used herein to refer to a textile substrate that is treated or coated with, i.e., has applied to its surface and/or is partially or wholly saturated with, a textile coating of the present disclosure, to reduce microplastic shedding of the textile substrate due to mechanical rubbing including but not limited to friction and abrasion.

The term “coating composition” as used herein is generally meant to refer to a composition for textiles comprising a primer and a polymer brush as described herein. The coating composition may contain components in addition to primers and polymer brushes, such as colorants. The use of the term “coating” in the term “coating composition” is not limited to the presence of the composition on a surface of a textile substrate, but is also intended to encompass a textile substrate that has been infiltrated with the composition, such that the composition is present within the fibres of the treated substrate. Unless specifically indicated otherwise, “coating” is used only as a term of convenience, and is not meant to be limiting as to the manner of application of the compositions disclosed herein, or their final location on and/or within a treated textile substrate.

The term “waterborne” when used with chemical, formulation or coating is generally understood to refer to the use of water as the solvent or carrier medium of the chemical, formulation or coating as opposed to an organic solvent.

The term “organic solvent” has its general meaning in the art and refers to a class of carbon-based chemicals capable of dissolving or dispersing one or more other chemical substances.

The term “catalyst” has its general meaning in the art and is generally a substance that increases the rate of a reaction and/or promotes a certain reaction pathway without itself being consumed.

The term “Lewis acid” has its general meaning in the art and is generally understood to be any substance, such as the H⁺ ion, that can accept a pair of nonbonding electrons.

The term “Lewis acid catalyst” refers to a Lewis acid such as acids and metal salts functioning as a catalyst in a reaction.

In the context of “treated textile,” “coated textile,” “treated textile substrate,” and “coated textile substrate”, the term “finish” is used interchangeably with “coating” or “coat”.

Unless specifically indicated otherwise, the term “deposit” is used only as a term of convenience and is not meant to be limiting as to a particular manner of application of the compositions disclosed herein.

Likewise, the term “graft” is used only as a term of convenience and is not meant to be limiting as to a particular manner of chemical bonding or attaching.

The chemical terms, including functional terms, used herein have meanings generally known in the art. Those skilled in the art are also familiar with the meaning of these terms. For example, the term “alkyl” as used herein refers to a branched or unbranched saturated hydrocarbon group of 1 to 18 carbon atoms, including for example, methyl, ethyl, n-propyl. The term “siloxane” as used herein refers to a functional group in organosilicon chemistry with the Si—O—Si linkage. The term “alkoxy” as used herein is generally represented as —OR, wherein R is an alkyl as defined above. The term “siloxy” as used herein is generally represented as

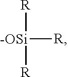

where R is an alkyl as defined above. The term “halide” as used herein refers to a halogen atom bearing a negative charge and can be fluoro, chloro, bromo or iodo.

The term “polymer” is used herein in its conventional sense to refer to a compound having two or more monomer units, and is intended to include homopolymers as well as copolymers. The term “monomer” is used herein to refer to compounds which are not polymeric.

Unless specifically indicated otherwise, the term “polymer brush” used herein is generally understood to have an elongated shape of a particular size in one direction related to the degree of polymerization in a first direction (i.e. its “length”) relative to the degree of polymerization in a second direction perpendicular to the first direction (i.e. its “width”). The length and width of the polymer brush can be controlled by methods known in the art, for example, by controlling the molecular weight of the polymer brush. In addition, the term “brush” is used only as a term of convenience and is not meant to be limiting as to the shape, morphology, or the function of the polymer brushes and the polymer brush layers described in the present disclosure.

For the purposes of the present specification and/or claims, and unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth herein are approximations that may vary depending upon the desired properties sought to be obtained by the present invention, inclusive of the stated value and has the meaning including the degree of error associated with measurement of the particular quantity. The term “about” generally refers to a range of numbers that one of ordinary skill in the art would consider as a reasonable amount of deviation to the recited numeric values (i.e., having the equivalent function or result). For example, this term “about” can be construed as including a deviation of ±10 percent of the given numeric value provided such a deviation does not alter the end function or result of the value. Therefore, a value of about 1% can be construed to be a range from 0.9% to 1.1%.

Unless stated otherwise herein, the articles “a”, “an” and “the”, when used to identify an element, are not intended to constitute a limitation of just one and will, instead, be understood to mean “at least one” or “one or more”.

### Overview

In general, the present disclosure is based on the discovery of a coating for textiles, comprising a primer layer, which is in intimate contact with a surface of the textile by bonding to the surface but also is in intimate contact with a polymer brush layer by bonding to the polymer brush layer. It has been found that after laundering or washing, a textile coated with an exemplary textile coating described herein can shed substantially less microplastic fibres, when compared with an uncoated textile. Further, the coated textile can still maintain its physical and comfort properties such as bending rigidity, surface structure, hydrophobicity, air permeability (i.e. breathability) and so on.

Without being limited to any particular theory, it is postulated that the substantial reduction in microplastic shedding of an exemplary coated textile of the present disclosure results from a low friction coefficient imparted by the polymer brush in combination with a bonding of the polymer brush to the textile surface through the primer bonded to the textile surface. As an abrasive uncoated textile/uncoated textile interface is replaced with a low-friction polymer brush/polymer brush interface upon rubbing, the microplastic shedding can be reduced.

In very general terms, abrasion is a process of two materials shearing past one another, damaging at least one of the materials in the process. Shear is generated during an interfacial contact between two materials. Hence, a lower friction is expected to generate less shear. A lower friction coefficient would therefore be desirable.

The textile coating compositions, coated textiles comprising the textile coating compositions described herein and methods of making the coated textiles and other features of the present disclosure are provided in greater detail below.

### Textile Coating Compositions

In general, a textile coating composition described herein comprises (a) a primer and (b) a polymer brush.

The primer is of general formula (I)

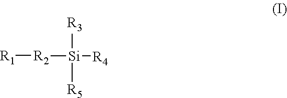

wherein R₁ forms a bond with the at least one surface of a textile and is selected from the group consisting of amine, alkoxy, hydroxy, acid, acrylate, halide, ester, ether, alcohol, vinyl, carboxylic, carbonyl, amino, and mercapto; R₂ is selected from the group consisting of alkyl, aryl, siloxane and any combinations thereof; and R₃, R₄ and R₅ are each independently hydroxy, alkoxy optionally substituted with an alkoxy, siloxy, halide, or alkyl; however, R₃, R₄ and R₅ are not simultaneously alkyl. In other words, at most two of R₃, R₄ and R₅ can be simultaneously alkyl.

In general, the primer as described herein is either commercially available or can be readily prepared from commercially available starting materials and/or reagents using methods known to those skilled in the art.

When deposited on the textile, the primer is in intimate contact with the textile surface due to the formation of a bond between R₁ of the primer and a functional group on the textile surface. In some embodiments, the bond between the primer and the textile surface is ionic, in some embodiments, the bond is covalent and in other embodiments, the bond is a hydrogen bond.

For example, when R₁ is an acid, it can form an ionic bond with an amide functional group of nylon, thereby allowing the primer to be deposited on the nylon surface. When R₁ is an amine, it can form a covalent bond with the surface of polyester through an aminolysis reaction, thereby allowing the primer to be deposited on the polyester surface. When R₁ is an alcohol, it can hydrogen bond with the surface of cellulosic fibres such as viscose (also called Rayon).

In some embodiments, R₂ is selected from the group consisting of alkyl, aryl, siloxane and any combinations thereof.

In some embodiments, R₃, R₄ and R₅ are the same. For example, they are all hydroxy, alkoxy or halide.

According to some embodiments, the R₁ of a primer described herein is a mercapto group. For example, the primer is 3-mercaptopropyltrimethoxysilane, 3-mercaptopropyltrichlorosilane, 3-mercaptopropyltriethoxysilane, 3-mercaptopropyldimethylmethoxysilane, 3-mercaptopropyldimethylethoxysilane, 3-mercaptopropyldimethylchlorosilane or 3-mercaptopropyldichloromethylsilane.

According to some embodiments, the R₁ of a primer described herein is an amino group. For example, the primer is (3-aminopropyl) triethoxysilane, (3-aminopropyl) trimethoxysilane, (3-aminopropyl) dimethylethoxysilane, (3-aminopropyl) dimethylmethoxysilane, (3-aminopropyl) trichlorosilane, (3-aminopropyl) dichloromethylsilane, or (3-aminopropyl) dimethoxymethylsilane.

According to other embodiments, the R₁ of a primer described herein is a vinyl group. For example, the primer is trimethyl (vinyl) silane, vinyl tris(2-methoxyethoxy) silane, methyl bis(trimethylsilyloxy) vinylsilane, or tris (trimethylsiloxy) (vinyl) silane.

In general, the polymer brush described herein forms a bond with at least one of R₃, R₄ and R₅ of the primer. The polymer brush comprises a polymer having an oxygen-containing backbone and having a glass transition temperature less than about 20° C. The polymer brush forms a bond with at least one of R₃, R₄ and R₅ of the primer to allow the polymer brush to grow or be grafted on a textile surface via the primer which bonds with the textile surface at R₁.

Without being limited to any particular theory, it is believed that a polymer having an oxygen-containing backbone, for example, —O— (i.e. an ether linkage) or —Si—O—Si—, along the backbone can provide a molecular flexibility, as reflected by a glass transition temperature of less than about 20° C. for the polymer. Persons skilled in the art would appreciate that such a polymer can be “liquid-like” under ambient conditions as further described below.

For example, the polymer brush is of general formula (II)

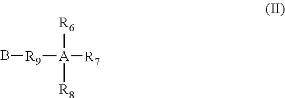

wherein A is Si or C; and B is the polymer. In some embodiments, B is selected from the group consisting of poly(ethylene glycol), polytetrahydrofuran, polyoxetane, pluronic, polyglycerol, polypropyleneglycol, polytetramethylene ether glycol, polybutylene oxide glycol, polypropylene oxide glycol, polidocanol, poly(p-phenylene oxide), perfluoropolyether, polydioxanone and polysiloxane. In some embodiments, R₆, R₇ and R₈ are each independently amine, alkoxy, hydroxy, halide, acid, acrylate, ester, alcohol, carboxyl or mercapto such that it may suitably react with the selected primer layer. In some embodiments, R₆, R₇ and R₈ are each independently halide, alkoxy, hydroxy or alkyl, with the proviso that at least one of R₆, R₇ and R₈ is halide, alkoxy or hydroxy to form a bond with at least one of R₃, R₄ and R₅ of a primer, when the at least one of R₃, R₄ and R₅ is not alkyl. In some embodiments, R₉ is absent or when present, R₉ is a linker but is not a repeating unit of the polymer.

In some embodiments, R₆, R₇ and R₈ are the same. For example, they are all hydroxy, alkoxy or halide.

In some embodiments, the linker R₉ is alkyl or an alkylamido group. For example when B is perfluoropolyether, R₉

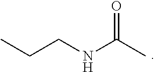

In general, the polymer brush is either commercially available or can be readily prepared from commercially available starting materials and/or reagents, including in accordance with preparation methods disclosed herein.

It is also possible that the polymer can grow first from a siloxane, silane or silyl ether functionalized monomer bonded to the primer. In one embodiment, the polymer brush is poly(dimethylsiloxane) (PDMS), which can be prepared by polymerization of a siloxane functionalized monomer 1,3-dichlorotetramethyldisiloxane (DCTMDS), which is bonded to at least one of R₃, R₄ or R₅ of a primer described herein when these groups are not alkyl, via a condensation reaction, and the PDMS brush then grows from the monomer bonded to the primer. In another embodiment, the silane functionalized monomer is silane perfluorpolyether (PFPE). In another embodiment, the silyl ether functionalized monomer is trimethoxysilylpropoxypolyethyleneoxide. In some instances, the monomers can also be 1,3-dichlorotetramethyldisiloxane, dichlorodimethylsilane, dimethyldimethoxysilane, dimethyldiethoxy silane, dimethylmethoxychlorosilane, 1,5-dichlorohexamethyltrisiloxane, or 1,7-dichlorooctamethyltetrasiloxane.

According to some embodiments, the polymer has a molecular weight equal to or less than about 100,000, equal to or less than about 50,000, equal to or less than about 20,000, equal to or less than about 10,000, equal to or less than about 5,000, equal to or less than about 2000, or equal to or less than about 500. In some embodiments, the polymer has a molecular weight of about 5,000 to about 20,000. In one embodiment, the polymer has a molecular weight of about 7,000. In other embodiments, the polymer has a molecular weight of about 500 to about 100,000. In one embodiment, when the polymer is PEG, it has a molecular weight equal to or less than about 500. In another embodiment, when the polymer is PFPE, it has a molecular weight equal to or less than about 2,000.

The polymer brushes described herein can be “liquid-like” in that they exhibit properties such as lubrication, oil repellency, rheological flow, etc. that are typically reserved for liquids.

In some embodiments, the polymer in the polymer brush has a glass transition temperature below about 10° C. In other embodiment, the polymer in the polymer brush has a glass transition temperature below about 0° C., below about −10° C. or below about −20° C.

It is expected that partly due to the “liquid-like” properties exhibited by the polymer brush described herein, the friction coefficient of a textile coated with an exemplary coating composition described herein can be lowered, thus contributing to a reduction of microplastic shedding.

The molar ratio of the primer to the polymer brush in an exemplary textile coating composition can be varied according to the number of alkyl groups present among R₃, R₄ and R₅ in the primer. For example, if two of R₃, R₄ and R₅ are alkyl, the molar ratio of the primer to the polymer brush can be about 1:1. If one of R₃, R₄ and R₅ is alkyl, the molar ratio of the primer to the polymer brush can be about 1:2. If none of R₃, R₄ and R₅ are alkyl, the molar ratio of the primer to the polymer brush can be about 1:3. Further, persons skilled in the art would recognize that since there is no perfect conversion efficiency, an excess amount of the polymer brush may be required.

In some embodiments, the primer-polymer brush coating composition is waterborne since the composition, including the primer and/or polymer brush, can be prepared in water without using any organic solvent. For example, the primer can be hydrolyzed or dissolved in water prior to being deposited on a textile surface. In one embodiment, the polymer brush can be prepared by a silanol polycondensation of a siloxane, silane or silyl ether functionalized monomer using water as the solvent. In some instances, a Lewis acid catalyst is used for the silanol polycondensation. In one instance, the Lewis acid catalyst is an acid such as HCI. In another instance, the Lewis acid catalyst is a metal catalyst. Fe³⁺ catalysts can be used and include, but limited to, Fe(OTf)₃, Fe(OTs)₃ and Fe(2-EH)₃. In some instances, the monomer is also hydrolyzed in the presence of the Lewis acid catalyst.

### Coated Textiles

In general, the textile coating compositions described herein can be used with any textile substrate amenable to use with such coating compositions. Suitable textile substrates include textiles having natural, synthetic, cellulose-based, or non-cellulose-based fibres or any combination thereof. Exemplary textile substrates include, but are not limited to, synthetic textiles (e.g. polyester, nylon, spandex, polypropylene, polyethylene), plant-based textiles (e.g. cotton, rayon, flax, jute, viscose) and animal based textiles (e.g. silk, wool, cashmere, mohair). Persons skilled in the art would be familiar with the various functional groups contained by the textiles.

For example, the textile can be nylon, polyester, acetate, acrylic, spandex, polyolefin, polyaramid, polyethylene, polypropylene, cotton, jute, hemp, bamboo, linen, wool, rayon, silk or any combinations thereof.

In general, an exemplary coated textile comprises a multilayer coating on its surface, wherein the multilayer coating comprises (a) a primer layer binding to the textile surface, wherein the primer layer comprises a primer as described above, and (b) a polymer brush layer comprising a polymer brush as described above. The exemplary coated textile can exhibit a substantive reduction of microplastic shedding due to friction or abrasion. In some instances, the coated textile shows a reduction in MPF shedding by about 96% even after repeated washing.

It should be appreciated that the coated textile can contain more than two layers so long as the external-most layer is the polymer brush layer and all layers underneath are bonded to each other, with a primer layer bonding with the external-most polymer brush layer, and a primer layer bonding with the surface of the textile.

In one embodiment, the coated textile is a coated nylon comprising a primer layer of silanols bonded to the surface of the nylon substrate, and a PDMS brush layer bonded to the silanol-coated nylon substrate. The primer silanol is 3-mercaptopropyltrimethoxysilane (MPTMS). When the primer is MPTMS, the coated textile shows a reduction in MPF shedding by about 93% even after repeated washing.

In another embodiment, the coated textile is a coated polyester comprising a primer layer of alkoxy silane bonded to the surface of the polyester substrate, and a PFPE brush layer bonded to the alkoxy silane coated polyester substrate. The primer alkoxy silane is 3-aminopropyltriethoxysilane (APTES). When the primer is APTES, the coated textile shows a reduction in MPF shedding by about 96% even after repeated washing.

### Methods of Preparing Coated Textiles

Coated textiles described herein can be prepared by any of a number of conventional coating processes commonly employed in the art. In general, the textile coating composition is applied to the textile to provide a treated textile in a manner that leaves the polymer brush layer as an outer layer accessible to reduce microplastic. The term “coating” as used herein encompasses both a surface coating as well as a coating that has infiltrated the textile to some degree, so long as, in the latter case, the coating composition is still accessible to reduce microplastic shedding.

The textile coating composition is applied to a textile to achieve a desired coating layer thickness and/or to achieve delivery of a desired amount of coating composition to the textile. The amount of coating composition used will vary with a number of factors, including, for example, the functional groups of the textile substrate. In general, the coating composition is applied in an amount of about 1-20 wt % after drying.

The coating composition is applied to at least one surface of the textile substrate, and may be applied to both a top and bottom surface of the substrate. As will be appreciated by those skilled in the art, the coating compositions can be applied by any suitable means, which may include continuous processes. For example, both the primer layer and the polymer brush layer can be formed by dipping, padding, spraying, drawing, using an applicator, in a gaseous phase, spinning, or using a plasma. Each layer may be deposited using its own technique, or the layers may be deposited using the same technique.

A coating solvent can be used. The solvent can be a polar (protic or aprotic) or nonpolar solvent. For instance, a suitable solvent can be water, methanol, ethanol, n-propanol, isopropyl alcohol, t-butanol, acetic acid, dimethylsulfoxide (DMSO), dimethylformamide (DMF), acetonitrile (MeCN), acetone, dichloromethane, tetrahydrofuran (THF), methyl acetate, ethyl acetate, diethyl ether, toluene, benzene, 1,4-dioxane, cyclohexane, hexane, pentane, or any combinations thereof.

In some embodiments, the polymer brush layer is first bonded to the primer layer and the layers are attached to the textile substrate. In some embodiments, the primer layer and the polymer brush layer are sequentially attached to the textile substrate. In some embodiments, the polymer brush layer is formed in situ from a suitable monomer that is bonded to the primer layer and polymerizes.

As will be appreciated by those skilled in the art, the chemistry used to bond the layers to each other and to the textile substrate can be varied using known methods and the order of attachment can also be varied. In addition, exemplary waterborne primer-polymer brush coating compositions and textile thus coated can be prepared using the methods described herein.

Scheme 1 below depicts a general process for preparing an exemplary coated textile:

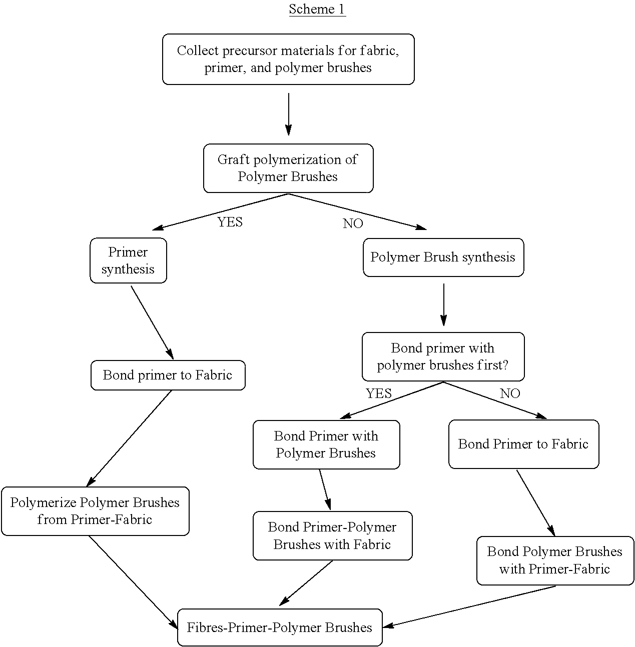

The textile coating composition may also be applied to substrates such as leather, films, wood, glass, metal and the like when they are coated with plastics.

Embodiments of the present disclosure will now be described by way of examples.

### Example 1 Primer-PDMS Brush Coated Nylon

In this example, a two-layer fabric coating composition was applied on the surface of nylon fabrics. The two-layer fabric coating is comprised of a nylon-specific primer layer and a PDMS brush layer. Specifically, a sulphonic acid terminated trimethoxysilane serves as the primer layer, which is ionically bonded with the nylon fabric surface using the acid group while decorating the surface of the fabric with silanols. PDMS brushes are then grown on the surface of the primer-coated nylon through polycondensation, anchored at these silanols.

Microfibre formation was evaluated over several laboratory washing cycles. The number and size of released microfibres was analyzed, for both coated and uncoated fabrics. Tribological analysis was conducted to quantitatively characterize the reduction in friction the fabric finish afforded, both in wet and dry conditions. Finally, physiothermal comfort was assessed and showed that the coated nylon maintained its attractive properties as a textile.

### Materials and Reagents

Pristine 100% nylon-6,6 woven fabrics (weight of 135 g/m²) were provided by Arc'teryx (North Vancouver, Canada). A nylon-6,6 sheet (thickness of 0.125±0.01″) and nylon-6,6 balls (diameter of 7/32″) were purchased from MacMaster-Carr (Atlanta, USA). 1,3-dichlorotetramethyldisiloxane (DCTMDS, 97%) and 3-mercaptopropyltrimethoxysilane (MPTMS, 97%) were obtained from Gelest Inc. (Morrisville, USA). Ethanol (EtOH, 95%), isopropyl alcohol (IPA, ≥99.5%), toluene (C7H8, ≥99.5%), hydrogen peroxide (H2O2, 30%), and sodium hydroxide (NaOH, 99.99%) were supplied by Ward's Science (Rochester, USA). Hydrochloric acid (HCI, 36.5-38%) and glacial acetic acid (AcOH, 99.7-100.5%) were obtained from VWR International (Radnor, USA). All the materials and reagents used were of analytical grade. Deionized water was used throughout the experiments.

The two-layer coated nylon was prepared in accordance with Scheme 2 below and further described below:

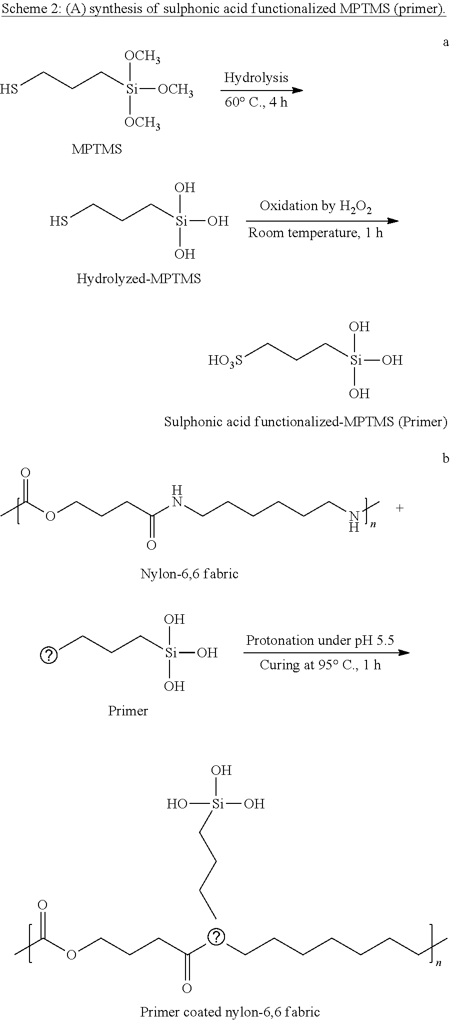

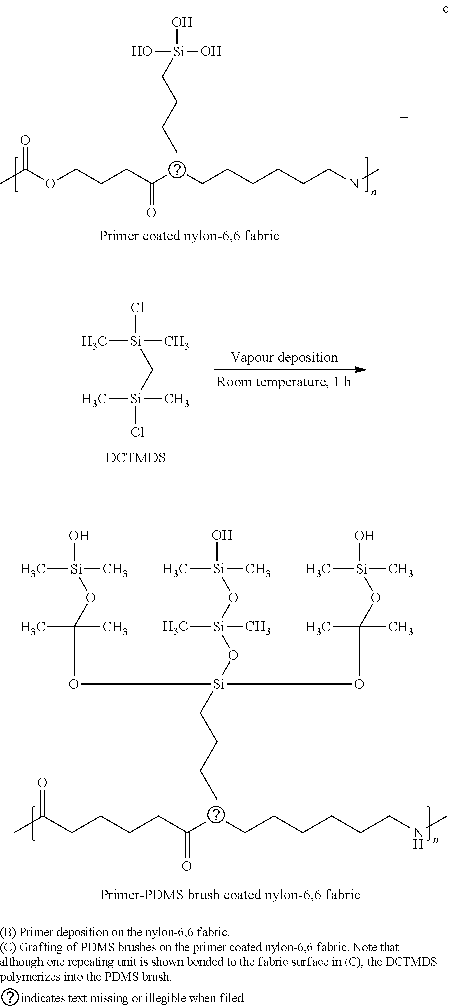

According to Scheme 2, first, the primer was synthesized through hydrolysis and oxidation of MPTMS to generate sulphonic acid-functionalized MPTMS in the presence of peroxide acting as the oxidizing agent (see step (A)). The resulting primers were then bonded to the nylon fabric surfaces through an ionic coupling of the sulphonic acid group with the surface amides of nylon at low pH, followed by curing at elevated temperature (see step (B)). It is postulated that the acid forms cations on the fabric surface, and the elevated temperature favors the formation of ionic bonds between the nitrogen atom of the amide group of the nylon fabrics and the sulfur atom of the sulphonic acid-functionalized MPTMS. Lastly, the PDMS brushes were grafted to the three surface silanol (Si—OH) groups now decorating the primer-coated fabric surfaces. In this step, the primer-coated nylon fabrics were exposed to vapors of the monomer precursor DCTMDS at room temperature. The grafting reactions then occur through polymerization of the reactive DCTMDS monomers, wherein the hydrolyzed Si—Cl group of DCTMDS reacts with a Si—OH group of either the primer coated fabric or the hydrolyzed monomer itself, forming covalently tethered PDMS brushes (see step (C)).

### Synthesis of Primer Layer

The primer layer was synthesized by mixing the MPTMS and EtOH uniformly at ambient temperature with continuous stirring for 2 h at 500 rpm. Next, deionized water and HCI with a molar ratio of 6.5:0.9 were added and mechanically stirred for 4 h at 60° C. The solution was then cooled to room temperature. To functionalize the mercapto groups of MPTMS to sulphonic acid groups, various molar concentrations of H₂O₂(0.02 to 0.04 M) were added to the solution and stirred for 1 h at room temperature. The molar ratio of MPTMS:H₂O₂ and the concentration of MPTMS in EtOH (wt/v %) for the primer are proved in Table 1. After 24 h of aging, the resultant primer was stored in a 10° C. refrigerator.

TABLE 1
Preparation of MPTMS primer layer

| | | MPTMS/Ethanol |
|---|---|---|
| Sample | MPTMS:H₂O₂ (moles) | (wt/v %) |
| 1 | 0.2:0.02 | 0.4 |
| 2 | 0.2:0.04 | 0.2 |
| 3 | 0.2:0.02 | 0.2 |
| 4 | 0.4:0.02 | 0.2 |
| 5 | 0.2:0.02 | 0.1 |
| 6 | 0.4:0.02 | 0.1 |

### Fabrication of Primer Coated Samples

The nylon fabrics were first ultrasonically rinsed in IPA for 30 min to remove any possible contaminants, and then dried at room temperature. The fabrics were cut in a circle of about 40 cm² (1 g of fabric) by a computer-controlled CO₂ laser cutter (Glowforge Pro™) and treated with oxygen plasma using a Harrick™ plasma cleaner (PDC-001-HP, USA) at a radio-frequency (RF) power of 45 W for 2 min. It is postulated that a plasma treatment can enhance the absorption of primer molecules to the fabric surface by increasing its surface energy.

The fabric samples were then dipped into the primer coating with a dipping speed of 15 mm/s using an automated dip-coater (Ni-Lo™ X1, Canada). The samples were immersed for 1 h at pH 5.5 with a 1:100 (wt/v %) sample to coating ratio, followed by air-drying for 10 min. The pH was adjusted by using small aliquots of diluted 1 M AcOH or 1 M NaOH as needed. This dipping-drying process was repeated two additional times, followed by a final cure at 95° C. for 1 h in an oven.

To coat the nylon-6,6 sheet and balls for tribology analysis, the nylon sheet was first cut into several discs with a diameter of 2.4″ by the same laser cutter as described above. The nylon discs and balls were then rinsed thoroughly with isopropyl alcohol (IPA) and toluene. Once dry, the nylon discs and balls were treated with oxygen plasma for 5 min, coated with the primer, and cured following the same dipping-drying procedures as described above.

### Deposition of PDMS Brush Layer

All primer-coated nylon-6,6 samples (fabrics, discs, and balls) were again treated with oxygen plasma for 2 min to ensure any residual methoxy groups on the surface were converted to silanols. After the plasma treatment, the samples were placed in a 20 cm×15 cm petri dish and DCTMDS was vapor-deposited for 1 h at room temperature using 200 μL of DCTMDS held in a glass vial. Finally, the samples were soaked in IPA and toluene, ultrasonically cleaned using a water bath sonicator for about 5 min to remove unreacted molecules from the surface followed by drying with compressed air.

### Characterization

Surface morphology was characterized using an Environmental Scanning Electron Microscope (SEM, FEI Quanta FEG 250) with an acceleration voltage of 10 kV. Before the SEM analysis, the samples were electrically grounded to the holder with conductive tape to minimize charging. Microfibre counting and size estimation were performed using a portable digital microscope (Jiusion™, 1000×) with a magnification range of 40× to 1000×. Fourier transform infrared (FTIR) spectra of the primer layer and fully coated fabrics were recorded with a spectrometer (Thermo Scientific™ iS50) equipped with an attenuated total reflectance (ATR) accessory, over the spectral range of 4000-500 cm⁻¹. Static water contact angle (WCA) measurements were performed using a goniometer (Rame Hart™ 260, USA). 8 μL of deionized water was deposited on the surface of the fabric with a 2 mL micrometer syringe (Gilmont™) at ambient temperature, and the WCA of the drop was analyzed by the DROPimage™ software. The wear of the coatings and changes in the surface roughness were investigated using a 3D laser scanning microscope (LEXT™ OLS5100, Olympus Corporation, Japan) with a 20× objective.

### Washing Tests

Cycles of fabric washing were conducted to investigate the amount of microfibres shed from treated and untreated nylon fabrics, following the ISO 105-C06:2010 standard method used to evaluate the color fastness of textiles for domestic and commercial laundering. Washing cycles were performed on fabric samples of about 40 cm², sealed at the edges after laser cutting to prevent edge fibres from shedding during washing. Deionized water containing a commercial detergent was used as a washing medium, with a fabric to water ratio of 1:150 (wt/v %), roughly 1 g of fabric in 150 mL of water.

A commercial plant-based detergent was chosen, composed of anionic and non-ionic surfactants, emulsifiers, alkoxylated polyethyleneimines, and fragrances. The fabric samples were attached to the bottom of borosilicate glass beakers and a magnetic stirrer to simulate the mechanical action associated with conventional laundering was placed on top of the sample. The wash liquids were added to the beakers and washed for 60 min at 40° C. on a hotplate. The fabric samples were not prewashed, and data for each washing cycle was repeated in triplicate for statistical analysis of the generated microfibres.

After each washing cycle, the fabric samples were removed from the beakers and squeezed gently to return the excess liquid into the wash container. The wash effluent that remained in the beaker was then transferred to a filtration system using a 10 mL pipet while stirring the wash water to maintain the homogeneity of the suspended microfibres in the solution. The microfibres from the wash effluent were separated using gravimetric filtration with a Buchner Funnel (Nalgene®, Thermo Scientific) through a nylon mesh filter, with an average pore width of 12 μm and diameter of 55 mm. The filtering system was rinsed with 500 mL of deionized water at 65° C. three times to avoid detergent coagulation on the surface of the filter. Next, the filtered samples were transferred to glass petri dishes and covered with aluminum foil to minimize contamination from air, and dried in an oven for 30 min at 105° C.

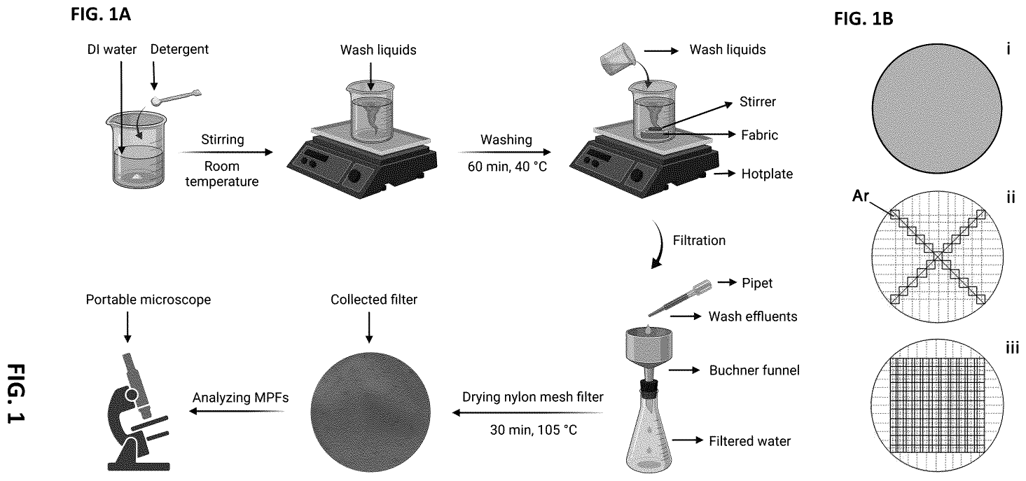

The fabric washing process, filtration of wash effluents, and MPF analysis methods are schematically presented in FIG. 1. An optical image of the laser-cut nylon mesh filter is shown in FIG. 1B(i).

### Microfibre Counting Technique

The surface of the filters containing the collected microfibres was analyzed by a SEM operated at a pressure of about 120 Pa. The filter surfaces were not pre-treated or sputter-coated prior to imaging. The number and size of microfibres released from the fabric samples after the washing cycles was analyzed following a previously developed counting procedure De Falco, F. et al. Evaluation of microplastic release caused by textile washing processes of synthetic fabrics. Environ. Pollut. 236, 916-925 (2018); and De Falco, F., et al. Quantification of microfibres released during washing of synthetic clothes in real conditions and at lab scale*. Eur. Phys. J. Plus 133, 257 (2018)). The counting method involves acquiring 21-micrographs through two orthogonal diameters of the filter surfaces (see FIG. 1B(ii)), then counting the number of microfibres observed in each of the micrographs (rectangular area, Aᵣ about 12.6 mm²) using the software ImageJ (released version 1.53n, USA), and calculating the average number of microfibres across all 21 photographs. Based on the amount of microfibres (nᵢ) detected in each of the micrographs, the number of fibres per unit area (Cᵢ) can be calculated as:

$${C}_{i} = {n}_{i} / {A}_{r} \qquad ( 1 )$$

where nᵢ is the number of fibres of micrograph i and Aᵣ is the area of each rectangle (about 12.6 mm²). The average number of fibres per unit area (C̅ₜ) and the total number of fibres in each filter (N) was then calculated according to Equations (2) and (3), respectively:

$$\overline{{C}_{ι}} = ( {\sum }_{i = 1}^{n} {C}_{i} ) / n \qquad ( 2 )$$

$$N = \overline{{C}_{ι}} \times {A}_{N} \qquad ( 3 )$$

where n=21, the total number of micrographs, and A_{N}=2375 mm², the total filter area.

The above microfibre counting technique was further expanded to increase its reliability by acquiring 121 total micrographs (see FIG. 1B(iii)). The total area of all 121 micrographs was about 1525 mm², or about 64% of the total filter area.

### Friction Measurements

The friction tests of different combinations of treated and untreated nylon 6,6 surfaces (balls and discs) were carried out using an Anton Paar™ MC102 rheometer with a tribology cell (T-PID/44). The rheometer measured the friction coefficient versus sliding distance. The friction efficient of four different ball/disc sample arrangements was investigated: brush/brush, brush/nylon, nylon/brush, and nylon/nylon (uncoated). The nylon ball was fixed to the measuring shaft of the rheometer, and the nylon disc was attached to the bottom of the tribology cell.

After each friction test, the nylon ball and nylon disc were replaced with new ones.

The experiments were conducted at 40° C. and ambient humidity, and was repeated at least three times.

For dry friction measurements, the nylon ball (primer-PDMS brush coated or uncoated) was slid on the surface of the nylon disc at a constant speed of 15×10−5 m/s for a total sliding distance of 4 mm. The normal force was set to 0.5 N for all friction experiments. Before the friction measurements, the measuring shaft was pressed down on the sample using 0.5 N for 240 s, and the temperature of the measurement stage was raised to 40° C. from room temperature.

For wet friction measurements, the tribology cell was filled with a mixture of commercial detergent and water such that the entire surface of the nylon disc was wetted with liquid (the volume of solution depending on the wettability of the surface). Next, the measuring shaft was pressed on the nylon disc, and the nylon ball (either primer-PDMS brush coated or uncoated) was slid on the surface of the disc with an increasing sliding velocity, from 15×10-4 to 1 m/s, over 300 s. The normal force and initial test conditions were the same for wet and dry friction measurements.

### Durability and Comfort Evaluation

The wash fastness of the treated fabrics was carried out to assess the durability of the coated fabrics. The wash fastness properties of the coated fabrics were studied according to ISO 105-C06:2010. The washed fabrics were dried at room temperature and the static water contact angles were measured after each washing cycle. The physical and comfort properties of the fabrics were evaluated by assessing bending rigidity and air permeability. The bending rigidity of the uncoated and coated fabrics was measured following a manual bending measurement technique used in the BS 3356-1990 standard.

The air permeability of the fabrics was measured using an air permeability tester (AKUSTRON™, Germany) with a pressure difference of 127 Pa, according to ASTM D737-96.

### Results

### Chemical Structure and Composition Analysis

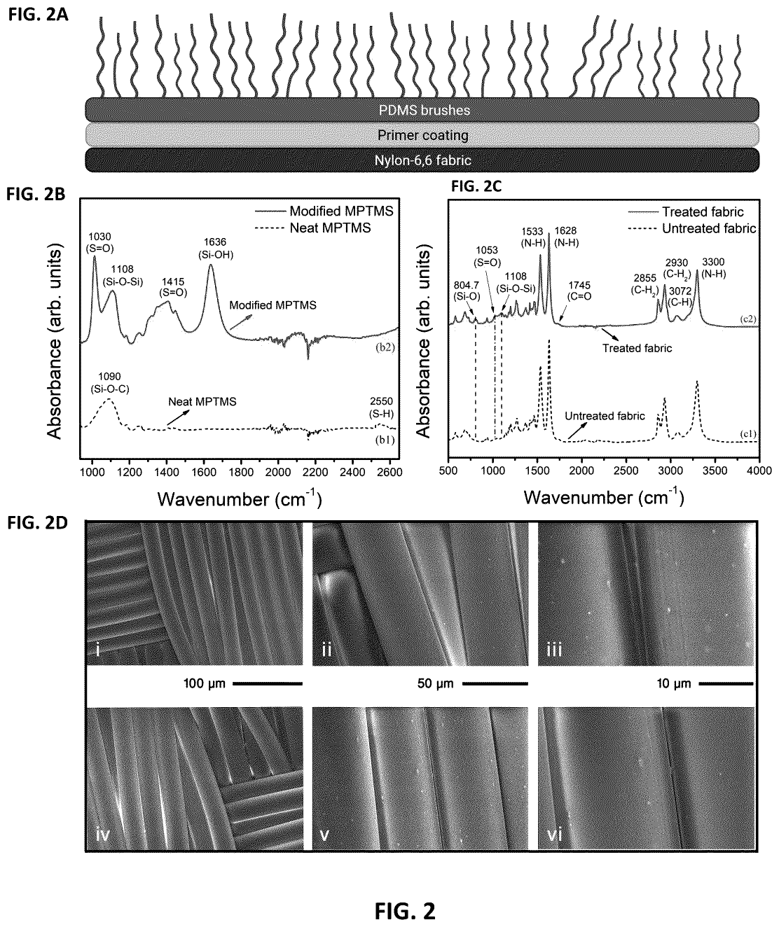

ATR FTIR analysis was performed to determine the chemical and compositional changes of the primer and two-layer fabric finish (see FIG. 2). FIG. 2B shows the ATR FTIR spectra of neat MPTMS and the H₂O₂-modified MPTMS. The neat MPTMS has two characteristic peaks at 1090 cm⁻¹ and 2550 cm⁻¹ (see curve b1), attributed to the stretching vibrations of Si—O—C and S—H groups, respectively. After oxidation by H₂O₂, two new peaks of S═O appeared at 1030 cm⁻¹ and 1415 cm⁻¹, indicating that the mercapto groups (S—H) of MPTMS had been oxidized to sulphonic acid groups (see curve b2). The absorption peak at 1108 cm⁻¹ corresponds to the stretching vibration of Si—O—Si groups, suggesting that some hydrolyzed-MPTMS monomers had polycondensed and oligomerized. However, the strong absorption peak at 1636 cm⁻¹ confirms the presence of silanol groups (Si—OH) necessary for grafting the PDMS brushes on the surface of the nylon fabrics, and also indicates that most of the hydrolyzed methoxy groups remained as silanols and not oligomeric reaction products. The modified MPTMS did not show any S—H absorption peaks after oxidation (see curve b2), indicating the successful formation of the primer.

ATR FTIR was also employed to validate the primer deposition and grafting of PDMS brushes on the surface of the nylon-6,6 fabric. FIG. 2C shows the ATR FTIR spectra of untreated and primer-PDMS brush treated nylon-6,6 fabrics. There are two characteristic absorption peaks positioned at 1628 cm⁻¹ and 1533 cm⁻¹ for both fabrics, corresponding to the stretching and in-plane bending vibrations of nylon's C═O (amide I) and N—H (amide II) groups, respectively (see curve c1 and c2). After treating the fabric with the primer and PDMS brushes, a new peak at 1053 cm⁻¹ was observed (see curve c2), corresponding to the stretching of the S═O group derived from the ionic bonding between the nylon fabric and the primer. In addition, the primer-PDMS treated fabric showed additional absorption peaks of Si—O and Si—O—Si at 804.7 cm⁻¹ and 1108 cm⁻¹, respectively (see curve c2). These peaks arise from the grafting of both the primer layer and PDMS brushes on the surface of the fabrics. Overall, the FTIR analysis indicated that the primer was successfully synthesized and that the primer and PDMS brushes were successfully grafted to the nylon fabric.

SEM was also carried out and the images in FIG. 2D (i to vi) showed that visually the primer-PDMS brush coating did not affect the fabric surface, highlighting the conformal, nanoscale morphology of the fabric coating.

### Assessment of Microfibre Shedding

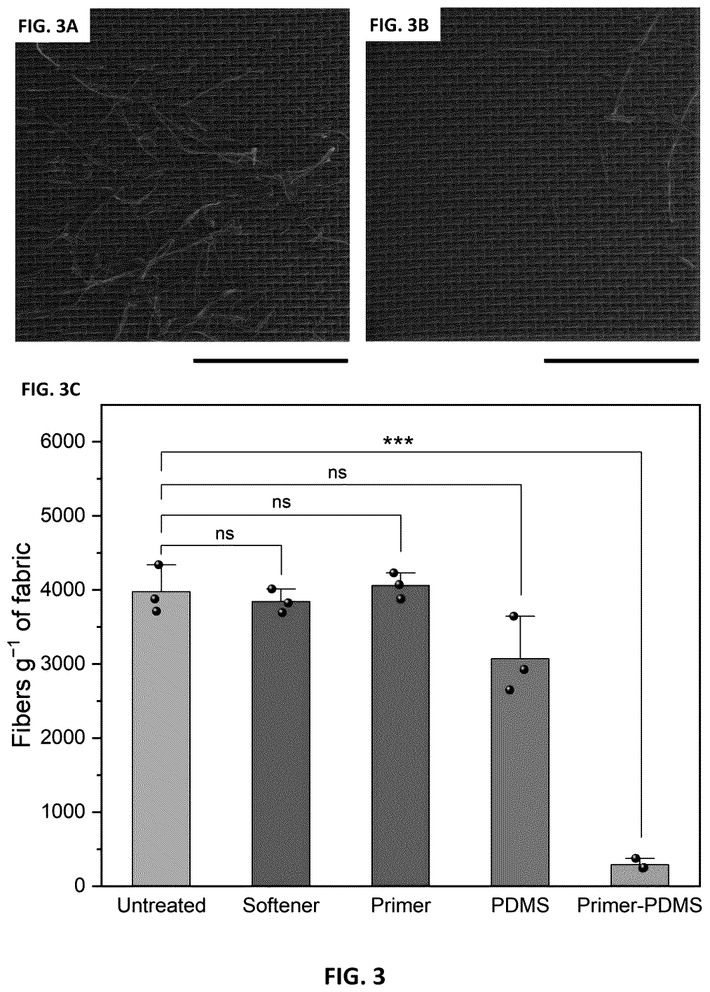

Nylon-6,6 fabric swatches, either untreated or treated with the primer-PDMS brushes, were then subjected to several washing cycles to assess the efficacy of the coating at reducing the formation of MPFs during laundering using the fabric washing technique and MPFs collection process and counting method depicted in FIG. 1 and described above. FIGS. 3A and 3B are SEM images of collected microfibres released from uncoated and coated nylon fabrics during washing. Many microfibres were observed on the surface of the filters from the washwater effluent coming from the uncoated fabrics (see FIG. 3A). In contrast, a substantially lower number of microfibres were shed from the primer-PDMS brush coated nylon fabrics (see FIG. 3B). The number of MPFs released per gram of fabric was 3700±400 fibres/gm for the uncoated fabric, and 255±45 fibres/gm for the coated fabric (see FIG. 3C). Accordingly, the MPFs generated per gram of nylon fabric was reduced by about 93% by the primer-PDMS brush coated fabric as compared to the uncoated fabric. The decrease in MPFs shed by the coated fabric was statistically significant (p-value: 0.0041 using a Student's t-test).

The MPF shedding reduction was also observed physically with SEM and chemically using FTIR.

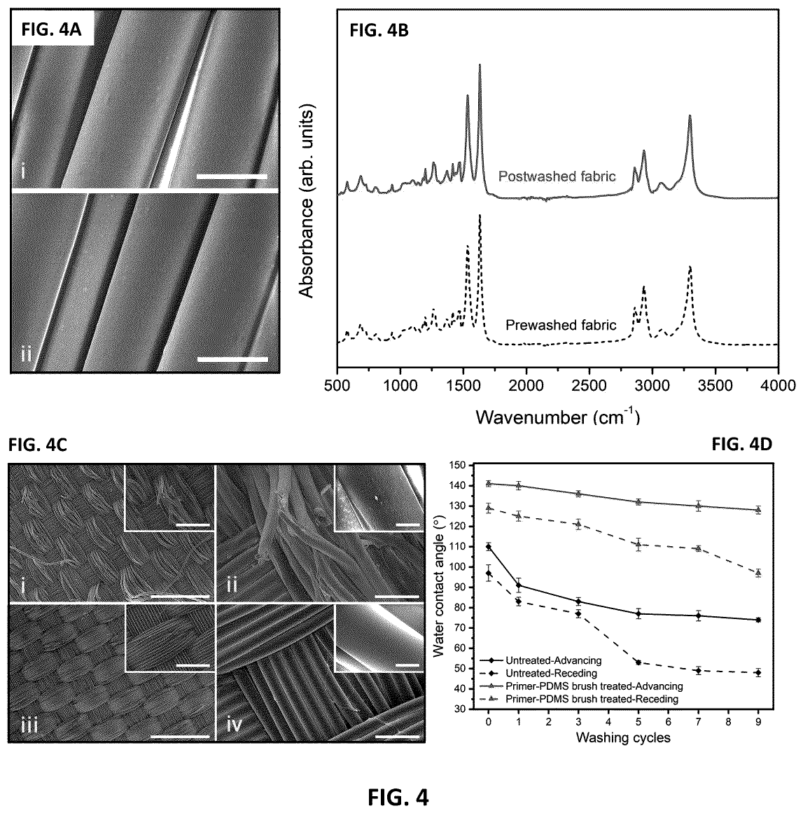

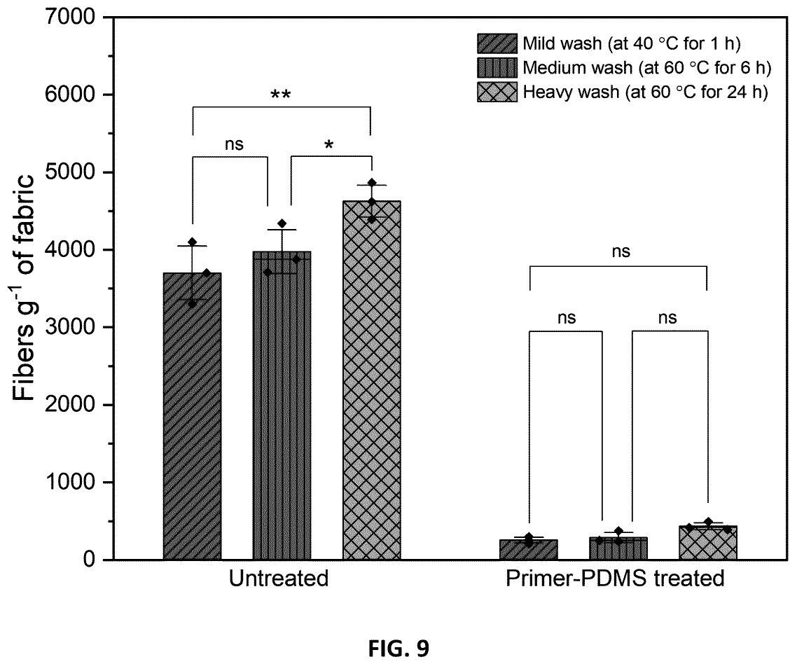

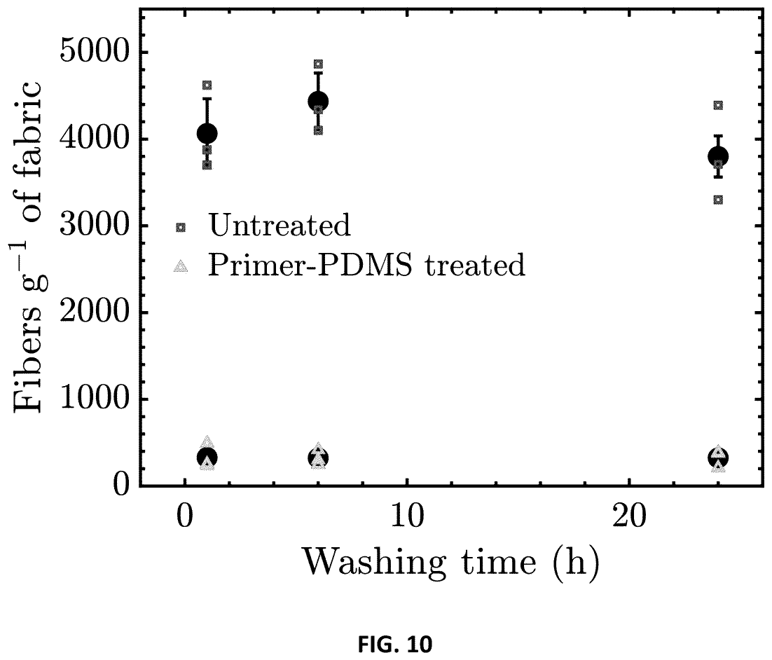

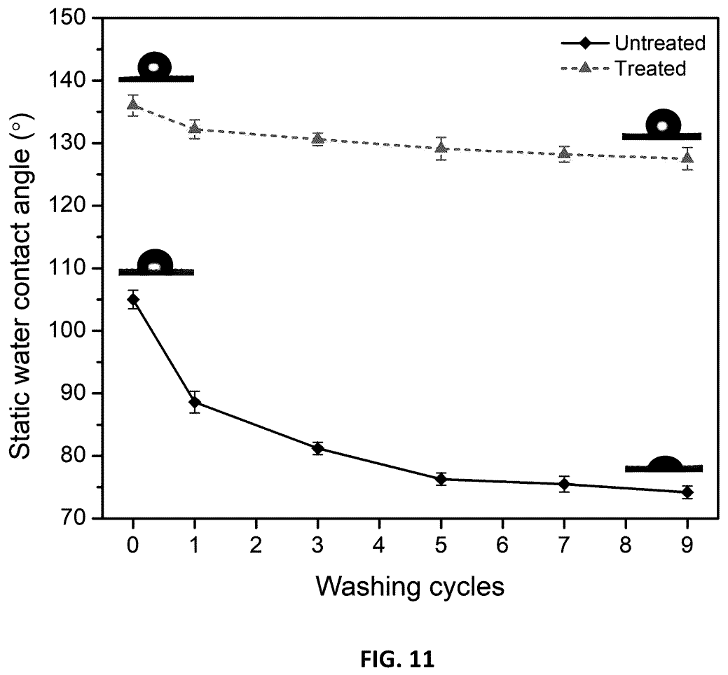

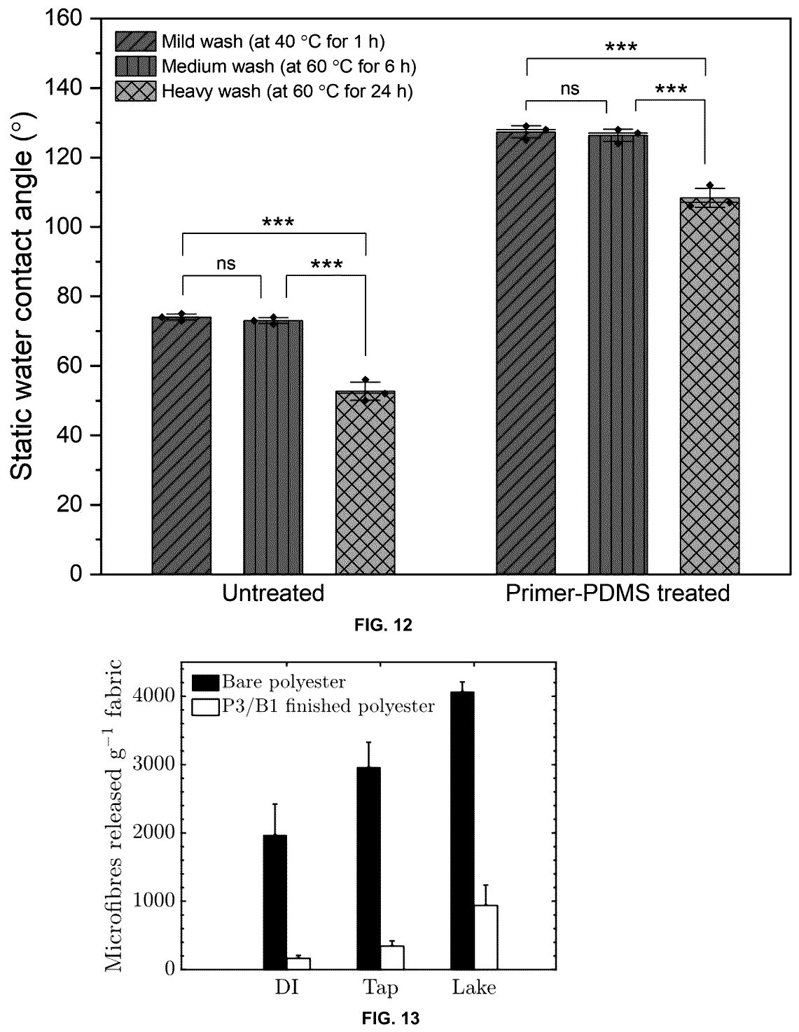

The abrasion experienced during washing did not alter the surface morphology of the coated fabrics (see FIGS. 4A (i and ii) and 4C (iii and iv)). On the other hand, the SEM images indicated that several fibres were broken and pulled-out during washing of the uncoated fabrics, and that the fibre surfaces were roughened (see FIG. 4C (i and ii)). After accelerated, heavy wash conditions (24 h, 60° C.), the wettability of both the bare and primer-PDMS treated fabric further increased (P value<0.001; FIGS. 11 and 12). However, the primer-PDMS treated fabric was still hydrophobic and reduced the shedding of microfibres by an amount statistically equivalent to the milder wash conditions (FIG. 9). As can be seen from FIG. 9, with respect to the untreated fabric, the mild wash (at 40° C. for 1 h) produced statistically less microfibres than the heavy wash (at 60° C. for 24 h), and the medium wash (at 60° C. for 6 h) produced statistically less MPFs than the heavy wash. Altering the temperature (40 to 60° C.) and duration (1-24 h) of the washing did not affect the MPF-shedding performance of the primer-PDMS treated fabrics, where statistically equivalent amounts of microfibres were shed (FIGS. 9 and 10). Bare nylon shed significantly (P value<0.01) more MPFs during the 60° C., 24 h heavy wash cycle. For the primer-PDMS brush treated fabric, all three wash cycles produced a statistically similar number of MPFs.

It is postulated that the washing abrasion resistance of the treated nylon fabric can be attributed to the strong ionic bonding of the primer layer to the fabric surface.

The mean length of MPFs released from bare uncoated nylon fabrics was 400±290 6 μm with a mean diameter of 13±2 μm, whereas the mean length of MPFs released from the coated nylon fabrics was 600±310 μm with a mean diameter of 11±3 μm. These differences were statistically insignificant (p-values of 0.1138 and 0.0903 for MPF length and diameter, respectively). Equivalence in shed MPF diameter and length between the coated and uncoated fabrics indicated that MPFs were being shed from the coated fabric in a similar manner as the untreated fabric, but less often. In addition, the primer-PDMS brush coating did not induce only the longest or widest fibres to be shed, supporting the hypothesis that the primer-PDMS brush coating caused a reduction in friction, which is unrelated to MPF diameter or length.

The IR spectra confirmed that both the primer layer and the PDMS brush layer were still present on the surface of the coated fabrics after the washing cycles (see FIG. 4B).

### Dry Friction Measurements

Ball-on-disc tribological characterization was performed to verify the hypothesis that the reduction in microfibre shedding was caused by the reduced friction of the finished nylon.

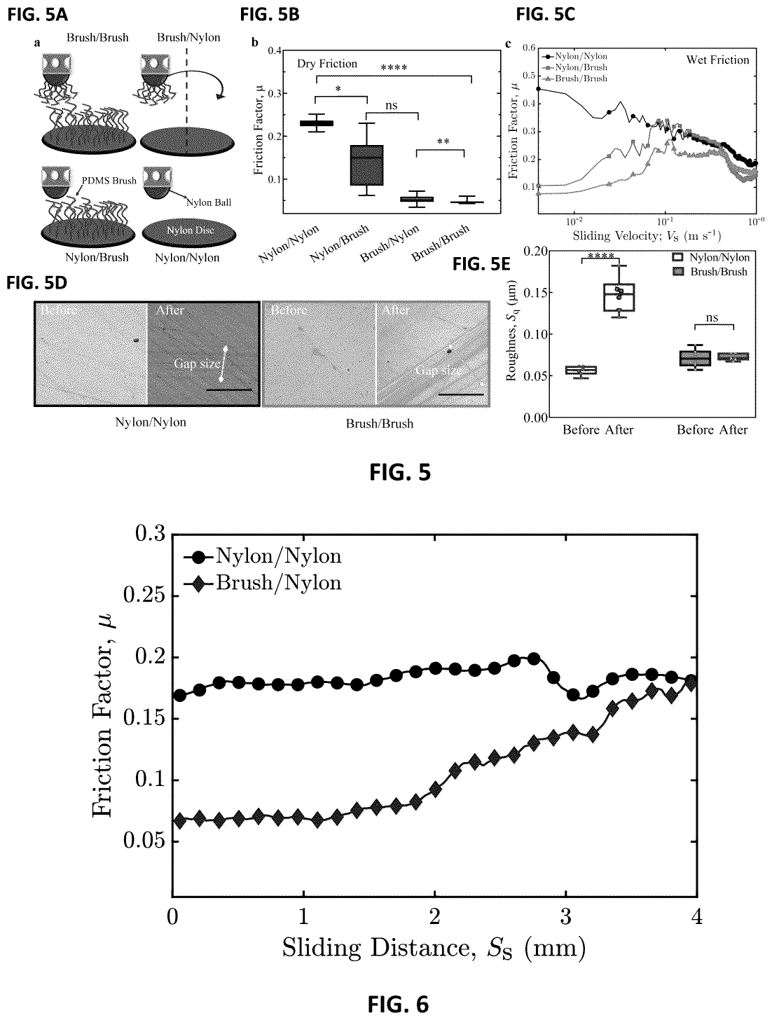

To replicate the mechanical and chemical properties of the fabric, the ball and disc used were both 100% nylon-6,6, either uncoated or primer-PDMS brush coated (shown schematically in FIG. 5A). The dry friction coefficient results of four ball/disc combinations (nylon/nylon, nylon/primer-brush, primer-brush/nylon, or primer-brush/primer-brush) are shown in FIG. 5B. Using a 4 mm sliding distance, the friction coefficient μ was highest for bare uncoated nylon rubbing against itself (μ=0.183). This value was reduced to μ=0.13 when either the ball or disc was coated with the primer and PDMS brushes, and was further reduced to μ=0.052 when both the ball and disc were coated with the primer-PDMS brush. Hence, when both the ball and disc were coated with the primer-PDMS brush (i.e. primer-brush/primer-brush arrangement), the dry friction coefficient was more than three times less than for the bare uncoated nylon/nylon. This was statistically significant (p-value<0.0001). This over three-fold decrease in friction corroborated the 93% reduction in MPF shedding when the abrasive bare uncoated nylon/nylon interface was replaced with the coated primer-brush/primer-brush interface during laundering.

For the mixed interfaces (primer-brush/nylon or nylon/primer-brush), the friction was still reduced by 29% (p-value: 0.01262), independent of whether the ball or disc was coated (p-value: 0.09967, ns=no significance in FIG. 5B). As the tribological interface was between the primer-PDMS brushes and nylon regardless of which surface was coated, this was expected. However, in the case of the primer-PDMS brush coated ball sliding on the bare uncoated nylon disc (primer-brush/nylon arrangement), the friction coefficient began to increase for longer sliding distances, and eventually approached the friction coefficient of the bare uncoated nylon/nylon interface (see FIG. 6). Given that nylon is itself abrasive, as evidenced by the microfibre shedding experiments, this result suggested that the primer-PDMS brushes were being removed from the nylon ball during the tribological analysis. Assuming Hertzian contact between the ball and disc, the diameter of the circular area of contact during the tribology experiments was about 200 μm, or 5% of the total sliding distance. This would be comparable to a fabric with 95% bare nylon fibres far from representative of a coated textile. In contrast, the nylon/primer-brush configuration where a bare uncoated nylon ball sliding on the primer-PDMS brush coated nylon disc, no increase in friction was observed, which would be comparable to a fabric with 50% coated fibres and 50% bare fibres. These results indicate that the coating remained effective at reducing friction even when half abraded away, and would thus continue to reduce microfibre shedding throughout the lifetime of the coated fabric.

### Wet Friction Analysis Using Wash Liquids

In a realistic laundering scenario, fabrics rub against one another in the presence of water and detergents. The wet friction between two solids separated by a liquid lubricant is presented by a Stribeck curve that plots the friction coefficient, μ, as a function of the sliding velocity, Vs. The Stribeck curves of bare and coated nylon surfaces using a commercial detergent solution as the lubricating liquid are shown in FIG. 5C. The configurations of the ball/disc were varied, including nylon/nylon, nylon/primer-brush, and primer-brush/primer-brush. Given the inconsistency observed for the primer-brush/nylon dry friction results above regarding the dry friction analysis, this interface was not studied for wet friction. At low sliding velocities, the bare uncoated nylon/nylon interface exhibited a higher wet friction coefficient (μ=about 0.36) compared to either the nylon/primer-brush or primer-brush/primer-brush interfaces (μ<0.1). The friction coefficient of the primer-brush/primer-brush interface was relatively constant, with a shallow increase observed around Vs=about 10⁻¹ m/s. This small rise in friction could have resulted from interfacial contamination from abraded nylon or debris. However, the friction coefficient decreased at higher sliding velocities, indicating that the source of the variance was transient.

For the nylon/primer-brush interface, the wet friction measurements again suggested partial abrasion of the coated nylon occurred as the sliding velocity was increased (see FIG. 5C). At low sliding speeds, the friction coefficient matched that of the primer-brush/primer-brush interface, but for speeds greater than Vs=about 10⁻¹ m/s the friction coefficient was the same as the uncoated nylon/nylon interface, indicating a degradation of the coating during wear. This result highlights the importance of a homogenous, durable low-friction fabric finish in at least two ways. First, any bare uncoated nylon will continue to shed MPFs, lessening the overall impact of the coating at reducing microfibre formation. Second, bare uncoated nylon will abrade the coated nylon over time, magnifying the inter-fibre friction and increasing the production of MPFs during repeated laundering.

The low and non-increasing friction of the primer-brush/primer-brush interface in both wet and dry conditions indicated that, when properly finished, the primer-PDMS brush coating resulted in a less abrasive and therefore less microfibre shedding environment for the nylon fabrics.

The morphology and roughness of the bare uncoated and primer-PDMS brush coated nylon surfaces before and after the wet friction testing (nylon disc from nylon/nylon or primer-brush/primer-brush) were studied. FIG. 5D shows images of the bare and primer-brush-coated nylon discs before and after the tribological analysis. When the bare nylon disc was abraded by the bare nylon ball, the resultant wear track gap size was 266±40 μm (FIG. 5D). A Hertzian contact analysis would predict a contact diameter of 264 μm for a nylon elastic modulus of 1.4 GPa, consistent with values reported for nylon 6,6 in a humid environment. In contrast, the gap was substantially larger (496±10 μm) after wet friction testing of the primer-brush/primer-brush interface, indicative of the softer PDMS outer surfaces as compared to nylon. Further, the measured root-mean-squared surface roughness, S_{q}, of the nylon surfaces indicated that only the bare uncoated nylon experienced substantial wear (see FIG. 5E). Before the wet friction testing, the roughness of the coated nylon disc was statistically equivalent to that of the bare uncoated nylon disc (p-value: 0.2172), confirming the presence of a thin layer that did not roughen the surface. However, the roughness of the bare uncoated nylon disc doubled after the testing, from S_{q}=0.072 to 0.142 μm, whereas the roughness of the coated nylon disc remained statistically unchanged (p-value: 0.28929, ‘ns’ in FIG. 5E). The unaltered roughness of the coated nylon disc after the wet friction testing further validated that PDMS brushes would lower the friction coefficient, thereby reducing the mechanical abrasion between fibres, which is responsible for MPF shedding.

### Influence of Washings on Fabric Surface Morphology and Wettability

Generally, washing causes mechanical damage to the surface of fabrics and can also alter their wettability. The impact of different washing cycles on coated and uncoated nylon fabrics was studied by analyzing the surface morphologies and measuring static water contact angles, as shown in FIGS. 4C and 4D. The SEM images of the uncoated and coated nylon fabric surfaces after nine washing cycles are shown in FIG. 4C (i to iv). The uncoated nylon fabric was visibly damaged by the mechanical abrasion during washing, and several broken yarns were observable on the surface of the fabrics (see FIG. 4C (i and ii)). The high magnification SEM inset in FIG. 4C (ii) also shows the roughened surface of the fibres after laundering, corroborating the roughness data in FIG. 5E. It was hypothesized that the initiation of microfibre shedding began at those defected surfaces on the nylon yarn during washings. For the primer-PDMS brush coated nylon fabric, also washed nine times, no observable changes were detected on the surface of the coated fabrics (see FIG. 4C (iii and iv)). The higher magnification SEM images (FIG. 4C (iv)) further indicated that the heavy washing cycles did not damage the nylon fabric or yarn surfaces. This result was in line with the roughness measurements (see FIG. 5E), where no change in surface roughness was observed in the metrological data after the wet friction testing.

The wettability of uncoated and coated nylon fabrics after nine washing cycles was studied by static water contact angle (SWCA) measurements. Before washing, the bare uncoated nylon fabric was slightly hydrophobic in nature, with a SWCA of 105° (see FIG. 4D). After five washing cycles, the SWCA was 76° and finally dropped to 74° after nine washing cycles. This 31° decrease in SWCA was significant (p-value: 0.00025), and suggested the formation of defects along the bare uncoated nylon surfaces that were observed under SEM (see FIG. 4C (i and ii)). For the primer-PDMS brush coated fabric, the SWCA was initially 136°, as the PDMS brush has a lower surface energy than nylon. The mean SWCA of the coated nylon fabric decreased 8° after nine washing cycles, but this was statistically insignificant (p-value 0.0610). Without being limited to any particular theory, it is postulated that the washing abrasion resistance of the coated nylon fabric likely arose from the strong ionic bonding of the primer layer, providing further support that the primer-PDMS coating was not damaged during the washing process.

### Physical and Comfort Properties

Studies were conducted to assess whether other fabric properties were not degraded as a result of the coating.

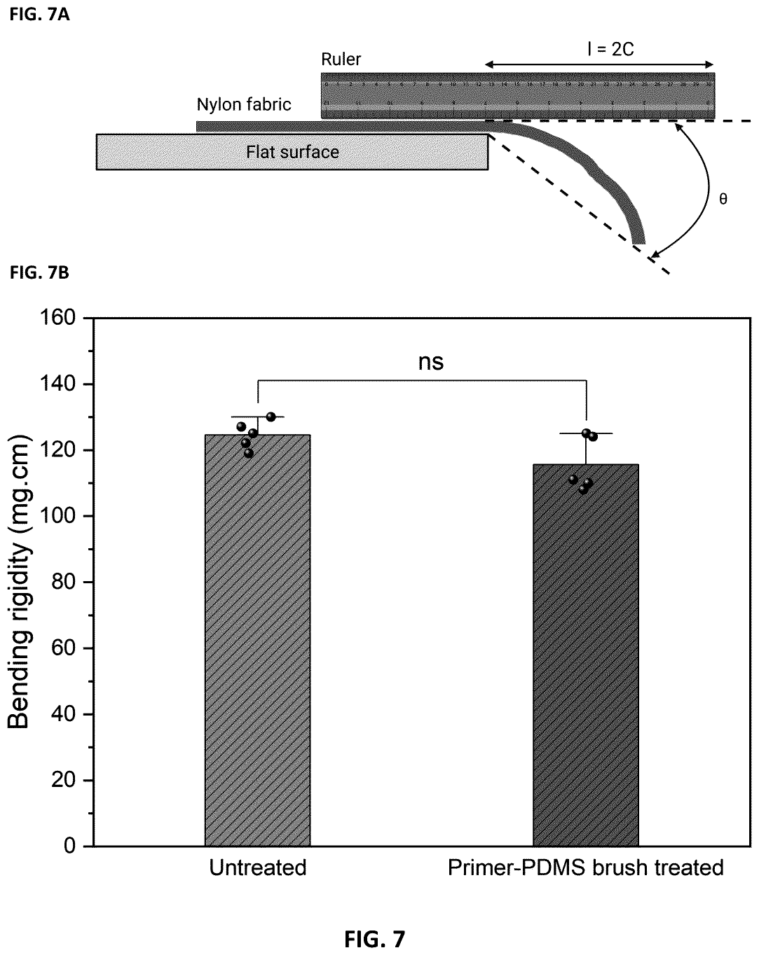

Fabric softness is a fundamental fabric characteristic in the textile industry, and is assessed via a fabric's bending rigidity (mg·cm), for example using the BS 3356-1990 standard. FIG. 7A shows a schematic diagram of the bending test using the BS 3356-1990 standard. The bending rigidity of the uncoated and coated nylon fabrics is shown in FIG. 7B. The bending rigidity of the primer-PDMS brush coated nylon fabric was statistically equivalent to that of the uncoated nylon fabric (p-value: 0.0628), indicating that the coating did not alter the mass of the fibres and maintained good softness of the coated fabrics.

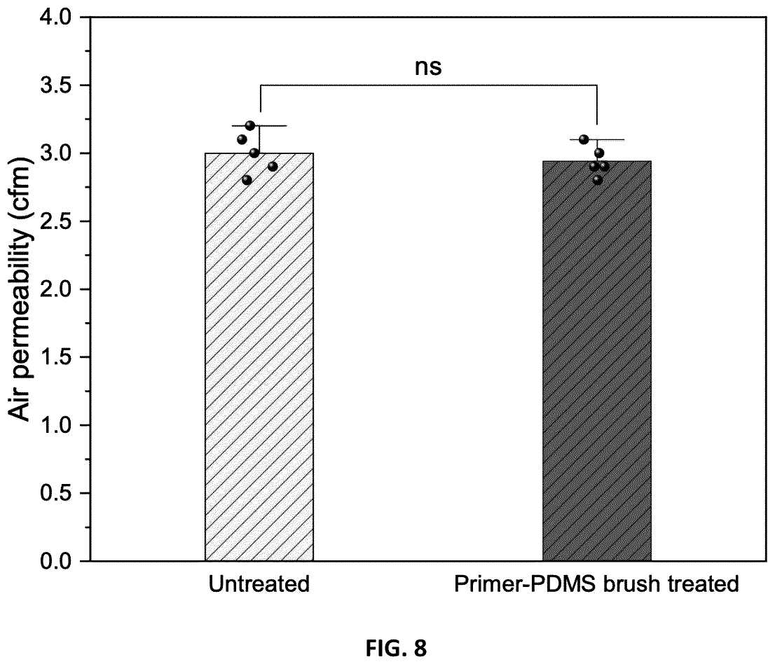

Air permeability is another fundamental textile property and an important factor in the comfort of a fabric. The air permeability of the uncoated and coated fabrics are shown in FIG. 8. The air permeability of the fabric was statistically unchanged before and after the primer-PDMS coating deposition (p-value: 0.5108). The SEM images of the primer-PDMS brush coated fabrics showed that the finishing treatment did not block the fibre spacing of the fabrics (see FIG. 2D (iv to vi)). Together with the handfeel results, these characterizations indicated that the primer-PDMS fabric coating would not decrease the comfort of nylon incorporating the coating.

### Example 2 Study of Primer-Polymer Brush Coatings

Various combinations of primer-polymer brush coatings were studied in this example.

The washing test and the collection of microfibres shed were carried out using analogous procedures as in Example 1.

To evaluate the microfibre shedding, microfibre counting was carried out using an analogous procedure as in Example 1.

Friction was measured in accordance with the procedure of Example 1.

In this Example, 3 primers and 4 polymer brushes as described below were studied. The fabrics studied were nylon 6-6 and polyester. The polymer brushes were applied to both uncoated and primer-coated fabric as shown in Table 2 below.

Primer 1 (P1): 3-mercaptopropyltrimethoxysilane (MPTMS). A mixture of MPTMS and ethanol in a beaker was placed on a magnetic mixer and stirred at ambient temperature for about 2 h. Deionized water and hydrochloric acid were then added with a molar ratio of 6.5:0.9, and the solution was stirred for an additional 4 h at 60° C. Next, hydrogen peroxide (0.02 to 0.04 M) was added to the above solution and stirred for 1 h at room temperature (molar ratio of MPTMS/hydrogen peroxide=0.2/0.02). The solution was aged for 24 h at about 10° C. and the resulting solution was P1.

To coat a fabric sample with P1, the sample was first ultrasonically rinsed in IPA for 30 min to remove any possible contaminants, and then dried at room temperature. The fabric sample was then treated with oxygen plasma at an RF power of 45 W for 2 min. The fabric sample was dipped into P1 with a dipping speed of 15 mm/s. The fabric remained immersed for 1 h at pH 5.5 with a 1:100 (wt/v %) fabric:P1 ratio, followed by air-drying for 10 min. The pH was adjusted by using small aliquots of diluted 1 M AcOH or 1 M NaOH as needed. This P1 treatment was repeated two additional times, followed by a final cure at 95° C. for 1 h in an oven.

Primer 2 (P2, reference): tetraethyl orthosilicate. P2 was used here as a negative control as it was expected to physisorb to the surface of fibres, thus unlikely resulting in microfibre shedding reduction.

Tetraethyl orthosilicate and ethanol were stirred (600 rpm) at room temperature. Water and HCI were added and the temperature was raised to 60° C. The solution was stirred for 3 h and then cooled to room temperature. The molar ratio of tetraethyl orthosilicate 24/ethanol/H₂O/H⁺ was 1/3.8/6.4/0.085. The solution was diluted with 5 g extra ethanol for every 10 g ethanol. The resulting solution was P2.

To coat a fabric sample with P2, the fabric sample was treated with oxygen plasma before being dip coated in the P2 solution (using the same dipping procedure as P1). Afterwards, the coated fabric was cured in an oven at 110° C. for 10 min.

Primer 3 (P3): 3-aminopropyltriethoxysilane (APTES). A 1% (v/v) 3-aminopropyltriethoxysilane/anhydrous toluene solution was prepared (P3) and a fabric sample was submerged in the P3 solution for 24 h at ambient temperature, followed by sonication in toluene for 10 min to remove loosely adsorbed 3-aminopropyl)triethoxysilane molecules. Next, the fabric was immersed in acidic water (pH=about 4.5 to about 5.0) for about 6 h at ambient temperature. The fabric was then washed with copious amount of water to remove unreacted molecules from the fabric surface, and dried with compressed air.

Polymer Brush Layer 1 (B1): poly(dimethylsiloxane) (PDMS) brush. A fabric sample was treated with oxygen plasma for 2 min. The fabric sample was then placed in a 20 cm×15 cm petri dish that also contained 200 μL of 1,3-dichlorotetramethyldisiloxane (DCTMDS). The fabric sample was held in the closed petri dish for 1 h at room temperature. Afterwards, the fabric sample was submerged in isopropyl alcohol and toluene, and ultrasonically cleaned using a water bath sonicator for about 5 min, and dried with compressed air.

Polymer Brush Layer 2 (B2): perfluoropolyether brush. A 1 wt % perfluoropolyether silane (silane PFPE obtained from Surfactis Technologies) in isopropyl alcohol was prepared with continuous stirring, and the pH of the solution was adjusted to between 4-5 (pH adjustment same as with P1). A fabric sample was then dipped in the B2 solution for 15 min (dipping procedure same as P1). After removal, the fabric sample was kept inside a fume hood to allow excess solution to drip off and evaporate. The fabric was cured in an oven at 110° C. for 15 min and after that, it was rinsed with excess isopropyl alcohol, and then dried with compressed air.

Polymer Brush Layer 3 (B3): poly(ethylene glycol) brush. A fabric sample was first treated with oxygen plasma for 2 min. The fabric sample was then dip-coated in a solution consisting of 1 μL of trimethoxysilylpropoxypolyethyleneoxide, a precursor for making PEG, methyl ether and 8 μL hydrochloric acid in 10 mL toluene for 18 h at room temperature. After dip coating, the fabric was washed with excess toluene, isopropyl alcohol and deionized water, and dried with compressed air.

Polymer Brush Layer 4 (B4, reference): polystyrene, monocarboxy terminated brush. B4 is not a “liquid-like” polymer brush and was explored as a negative control. A fabric sample was first treated with oxygen plasma for 2 min. The fabric sample was then dip-coated in a solution consisting of 0.5 wt % of polystyrene, monocarboxy terminated in toluene for 0.5 h at room temperature (dipping procedures same as P1). Then, the fabric was cured in an oven at 80° C. for 1 h. It was then rinsed with toluene, isopropyl alcohol and deionized water, and dried with compressed air.

As noted above, although the procedure above for polymer brush layer B to B4 refers generally to a “fabric sample”, the fabric sample was either uncoated or coated with one of the primer layers P1 to P3 described above.

The results of this study are shown in Table 2 below.

TABLE 2
Tests showing the efficacy of the primer layer + polymer brush layer at
reducing the shedding of microfibres from the fabric after three washing cycles

| | | | | | | | Friction |
|---|---|---|---|---|---|---|---|
| | | | Polymer | Microfibres | Microfibres | Friction | Coefficient |
| | | Primer | Brush | (per g of | Reduction | Coefficient | Reduction |
| Test | Fabric Type | Layer | Layer | fabric) | (%) | (μ) | (%) |
| 1 | Nylon 6-6 | — | — | 1945 ± 216 | — | 0.38 | — |
| 2 | | P1 | — | 1966 ± 400 | 0 | 0.41 | 0 |
| 3 | | — | B1 | 1200 ± 355 | 38 | 0.41 | 0 |
| 4 | | P2 | B1 | 2004 ± 154 | 0 | 0.14 | 62 |
| 5 | | P1 | B1 | 123 ± 32 | 94 | 0.08 | 79 |
| 6 | | — | B2 | 1229 ± 187 | 36 | 0.29 | 24 |
| 7 | | P2 | B2 | 2133 ± 383 | 0 | 0.22 | 43 |
| 8 | | P1 | B2 | 167 ± 52 | 91 | 0.17 | 54 |
| 9 | | — | B3 | 1535 ± 394 | 21 | 0.32 | 17 |
| 10 | | P2 | B3 | 2417 ± 426 | 0 | 0.24 | 37 |
| 11 | | P1 | B3 | 236 ± 55 | 88 | 0.22 | 42 |
| 12 | | — | B4 | 2080 ± 281 | 0 | 0.50 | 0 |
| 13 | Polyester | — | — | 2355 ± 399 | — | 0.33 | — |
| 14 | | P3 | — | 2166 ± 82 | 8 | 0.29 | 13 |
| 15 | | — | B1 | 1969 ± 379 | 16 | 0.42 | 0 |
| 16 | | P3 | B1 | 335 ± 104 | 86 | 0.03 | 91 |
| 17 | | P2 | B1 | 1550 ± 234 | 34 | 0.03 | 90 |
| 18 | | — | B2 | 679 ± 75 | 71 | 0.20 | 40 |
| 19 | | P2 | B2 | 1777 ± 230 | 25 | 0.15 | 55 |
| 20 | | P3 | B2 | 102 ± 55 | 96 | 0.04 | 89 |
| 21 | | — | B3 | 1888 ± 443 | 20 | 0.38 | 0 |
| 22 | | P2 | B3 | 1194 ± 451 | 49 | 0.20 | 38 |
| 23 | | P3 | B3 | 380 ± 55 | 84 | 0.10 | 69 |
| 24 | | — | B4 | 2462 ± 135 | 0 | 0.35 | 0 |

Tests 1 and 13 show the microfibres shed from bare uncoated nylon and polyester, respectively.

Tests 3, 6, 9, and 12 show that the polymer brush layer alone on nylon did not substantially reduce microfibre shedding. Similar results were observed on polyester in Tests 15, 21, and 24. Without primer layers bonded to the fabric surfaces, the polymer brush layers by themselves did not appear to reduce the shedding of microfibres substantially.

Tests 2 and 14 show that fabrics only coated with a primer layer statistically shed the same amount of microfibres as the uncoated fabric, suggesting that the primer layers by themselves did not appear to reduce microfibre shedding.

Tests 4, 7, 10, 17, 19, and 22 show that a primer layer (P2) that does not strongly bond to the fabric was not effective at substantially reducing microfibre shedding.

Tests 5, 8, 11, 16, 20, and 23 show that combinations of a primer layer strongly bonded both to the fabric and to a polymer brush layer resulted in a substantial reduction in microfibre shedding, ranging from an 84% to a 96% reduction.

While polymer brush layer B2 showed some microfibre shedding reduction without a primer layer (Test 18, a 71% reduction), the performance was improved (Test 20 with a 96% reduction) with the addition of the strongly bonded primer layer P3.

As would be appreciated by the skilled persons in the art, polymer brush layers B1, B2, and B3 are all “liquid-like” polymer brushes, meaning they can act as a lubricant during abrasion. As a negative control, polymer brush B4, which is not “liquid-like”, was also studied. No reduction in microfibre shedding was observed according to the results in Table 2.

### Example 3 Handwashing Tests

### Method

The hand washing process was the same for both coated and uncoated 100% polyester swatches. The swatches were laser cut in the same manner as the machine washed swatches as noted in Example 1, but in squares with a side length of 15 cm. Next, swatches were gently rinsed in deionised (DI) water for 5 minutes in a 5 L stainless steel bowl at 25±2° C. water temperature. After the initial rinsing process, the bowl was emptied and 1 L of fresh DI water (at 25±2° C.) was mixed with 1.5 g of standard detergent (AATCC #48805B-WOB, high efficiency liquid detergent, without optical brightener). The fabric swatches were then washed by rubbing against a wooden wash board at a rate of 18 rubs/minute for 5 minutes switching the side of the fabrics in contact with the wash board at the 2:30 minute mark. Following this, both the fabrics and wash board were finally rinsed with 250 mL of DI water to ensure all the loose MPF were within the wash water and that any detergent buildup was removed. Filtration, drying, and MPF counting were then performed in the same manner as with the machine washing tests described in Example 1.

In addition to evaluating DI water as a hand washing medium, tap water and water sourced from Lake Ontario were also utilized. Hardness strips were used assess the water hardness, following the same hand washing procedure noted above, except in any step where DI water was used (initial rinse, hand washing, and final rinse), it was replaced by either the tap water or lake water, respectively.

For this example, a 100% polyester sample was coated with Primer P3 (APTES) and polymer brush B1 (PDMS) using an analogous procedure as provided in Example 2.

### Results

The results of this study are shown in Table 3 below and also in FIG. 13.

More MPFs were shed when the water hardness was increased, for both uncoated and uncoated fabric samples. For example, about twice as many MPFs were released from the uncoated polyester in the lake water compared to the DI water. However, the fabric finish comprising P3 and B1 was still able to substantially reduce the amount of MPFs released, with reductions of 92%, 88%, and 77% for the deionised, tap, and lake water, respectively.

TABLE 3
Results from handwashing of bare polyester and polyester finished
with the P3 primer and B1 polymer brush formulation

| | MPF Shed g⁻¹ Fabric | MPF Shed g⁻¹ Fabric |
|---|---|---|
| Water Type | (Bare) | (Finished) |
| DI | 1970 ± 450 | 165 ± 43 |
| Tap | 2960 ± 370 | 344 ± 75 |
| Lake | 4070 ± 140 | 940 ± 300 |

### Example 4 Study of Washing Coated and Uncoated Fabrics Together

This study investigated the MPF reduction performance of an exemplary primer-polymer brush coating when a fabric sample coated with such coating was washed together with an uncoated fabric sample.

### Materials

100% polyester fleeced fabric, unfinished, was provided by MAS Active. Two different colours, red and blue, were used, but otherwise the fabrics were identical.

Primer P3 (APTES) and Polymer Brush Layer B1 (PDMS brush) of Example 2 were used.

### Methods

Primer P3 and subsequently Polymer Brush Layer B1 were applied to a fabric sample, similar to Test 16 in Table 2 of Example 2.

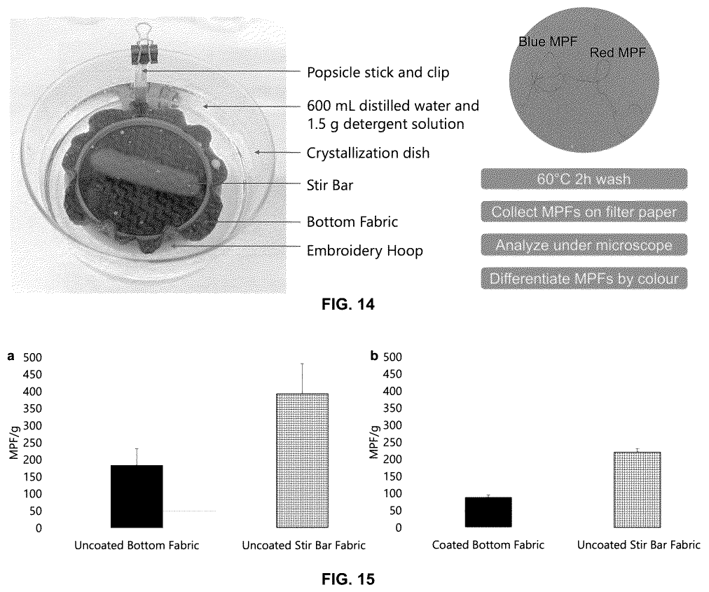

To wash the coated and uncoated fabrics together, a modified version of the “Assessment of Microfibre Shedding” method described above was developed, as shown in FIG. 14. According to the modified method, the bottom fabric was held stationary by fastening in an embroidery hoop, and the other colour fabric was hand sewn in a pouch to fully enclose a magnetic stir bar. This configuration allowed the two fabrics to rub against one other uniformly. During the experiment, the colour of the MPF was also recorded in order to determine whether the MPF being released originated from which coloured fabric. Using this colour differentiation thus enabled the determination of whether coated or uncoated MPFs were being released when both coated and uncoated fabrics were washed together.

The results of this study are shown in FIG. 15.

FIG. 15A shows the results when two uncoated fabrics were washed together. The fabric within the embroidery hoop was labeled as the “Bottom Fabric” and the fabric covering the magnetic stir bar was labeled as the “Stir Bar Fabric”. According to FIG. 15A, the Stir Bar Fabric showed roughly twice as many MPFs being released per gram fabric as when in the embroidery hoop, likely because the Stir Bar Fabric was always being rubbed against the Bottom Fabric, whereas only the portion of the Bottom Fabric directly under the stir bar was being rubbed at any given time.

When compared with FIG. 15A, FIG. 15B shows the following: first, when the Bottom Fabric was coated with the P3/B1, about 50% reduction in MPF release was observed for the Bottom Fabric. This indicates that the coating can still reduce MPF release, even when rubbed against an uncoated fabric. Second, the uncoated Stir Bar Fabric released about 40% less MPFs when the Bottom Fabric was coated. This indicates that the coating can even reduce MPF release for uncoated fabrics, as what is rubbing against them exhibits lower friction.

According to FIG. 15, the results suggest that a primer-polymer brush coatings in accordance with the present disclosure can still be effective at lowering MPF release even when coated fabrics are washed together with uncoated fabrics. The extent of MPF reduction of the coated fabrics may depend on the percentage of fibres coated, and/or the orientation of the fabrics during the washing process (that is, whether the coated fabrics are mostly rubbing against the coated or the uncoated fabrics).

### Example 5 Study of Airborne MPF Release in Coated Fabrics

This study investigated the extent of reduction of MPFs released into the air when coated fabrics were rubbed against each other.

### Materials and Reagents

Pristine 100% polyester prefinished one-sided fleece fabrics (weight of 180 g m⁻²) from Arc'teryx and double-sided fleece fabrics (weight of 210 g m⁻²) from MAS Active were used. 3-APTES (98%), hydrochloric acid (HCI, 36.5-38%), and glacial acetic acid (AcOH, 99.7-100.5%) were purchased from VWR International. DCTMDS (97%) was supplied by Gelest. Isopropyl alcohol (IPA, 99.5%), toluene (C7H8, 99.5%), and sodium hydroxide (NaOH, 99.99%) were supplied by Ward's Science. All the chemicals and solvents were used without further purification, and deionized water (DI) was used.

### Preparation of APTES-PDMS Brush Coated Fabrics

The APTES-PDMS brush coated fabrics were prepared using a method similar to the method described in Example 2.

APTES and toluene (concentration of APTES in toluene=1 v/v %) were mechanically mixed for 24 h at ambient temperature. Afterward, the solution was transferred to a 250 mL media container and stored for later use.

The polyester fabric samples underwent sonication three times for 30 min, alternating with isopropyl alcohol (IPA) and DI, then drying in an oven at 65° C. for 4 hours to eliminate potential contaminants prior to coating deposition. The fabrics were then cut into two size circles of roughly 145 cm² for the bottom fabric and 15 cm² for the upper fabric using a computer-controlled CO₂ laser cutter (Glowforge Pro) and exposed to oxygen plasma for 10 min using a Harrick plasma cleaner (PDC-001-HP) at a radio-frequency power of 45 W. The plasma-treated fabric samples were then dipped into the APTES primer solution for 24 h at ambient temperature, followed by rinsing thoroughly with toluene for 10 min to remove loosely adsorbed APTES molecules. The ethoxy groups of the APTES molecules were then hydrolyzed in an acidic water solution (pH 4.5-5.0) for 6 h at ambient temperature. The APTES coated polyester fabrics were washed with an excess flow of DI to remove unreacted molecules from the surface and dried with compressed, room-temperature air.

The APTES primer-coated polyester fabrics were put in a 150 mm×20 mm petri dish containing 200 μL of DCTMDS in 4 glass vials to grow the PDMS brushes. The fabrics were kept in the closed petri dish to allow for vapor deposition of the DCTMDS for 1 h at room temperature. Next, the samples were taken out, washed with IPA and toluene, and dried with compressed air.

### Abrasion Tests

A Martindale tester (James Heal model 1605 midi-Martindale) was used to quantify the abrasion resistance of the coated polyester fabric samples against one another, following a technique modified from the ISO 129477-2:2016 standard. The ISO standard was modified by replacing the standard abradant with the same fabric as the fabric being tested. In addition, the polyurethane foam material and the typical woven felt fabric were not used as standard underlays to prevent system contamination from extra fibers unrelated to the test fabrics. The standard underlays were thin and smooth polyester sheets (thickness of 0.06 mm), which helped rinse off the released microfibers more easily from the system after abrasion. To prevent cross-contamination between samples and also to collect the MPFs, a 3D printed polylactide (PLA) ring with an inner diameter of 15.5 cm, thickness of 0.3 cm, and height of 7.7 cm was mounted on the station. An external pump system was also installed to filter the airborne microfiber formed inside the PLA chamber. The whole abrasion system was fully isolated (named Type-2 isolation) using a custom-designed cover made from a thin polyester sheet.

The endpoint of the abrasion test was determined when the fabrics show thread breakage or worn-off areas, as mentioned in the ISO standard.

Both dry and wet abrasion methods were applied. During a wet abrasion, both top and bottom fabrics were prewetted (maintaining fabric saturation level 75%-80% during abrasion cycles). Then, the prewetted top and bottom fabrics were rubbed against each other in the Martindale instrument, following James Heal's Aqua Abrasion testing method. In contrast, fabrics were rubbed without pre-wetting for a dry abrasion.

The abrasion test was performed with 12 kPa pressure and was stopped after 1000 cycles (dry abrasion) and 500 cycles (wet abrasion) when fabric pilling was observed.

### Microfiber Counting and Measuring Techniques

After each abrasion cycle, the fabric samples were removed from the station, and the MPFs released into the air (here inside the PLA chamber) and onto the apparatus and fabrics were collected. AATCC High Efficiency standard liquid detergent solution without optical brighter (4 g detergent per liter of water) was used to rinse the apparatus, and the resulting rinse solution was filtered to collect the generated microfibers for further analysis. To better extract the microfibers from the fabrics, the detergent solution with fabric samples was sonicated for 5 min and filtered after each abrasion cycle. The microfibers released from the fabric samples were measured using the same Microfibre Counting Technique as described in Example 1.

MPF release was also monitored by weighing. In the weighing method, the weight of the bare filters and filter containing microfibers was taken separately, and then the actual MPF weight was measured by subtraction. The fabric samples were not prewashed, and data from each abrasion cycle was counted and measured three times for statistical analysis of generated microfibers.

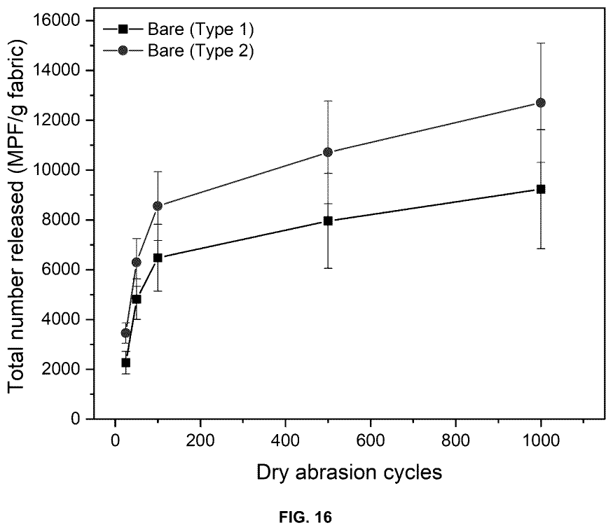

Results. After each abrasion cycle, the number of MPFs released from the bare and APTES primer+PDMS brush ocated polyester fabrics was quantified. In the abrasion experiment, both partially isolated (Type 1) and fully isolated (Type 2) conditions were employed to evaluate the reliability of the developed system. In the Type 1 condition, the released airborne microfibers were collected without using a polyester cover, whereas in the Type 2 condition, they were fully isolated. The total number of MPFs extracted from the Type 1 and Type 2 conditions after 1000 abrasion cycles was 9,200±2,400 and 12,700±2,400, respectively (FIG. 16). A statistically significant (P value 0.047) increase in the number of microfibers were captured in the Type 2 condition compared to the Type 1 condition, indicating that many microfibers were released into the surrounding environment in the partial isolation system. Therefore, the Type 2 condition, a fully isolated condition, was selected to confirm the maximum number of microfibers captured during abrasion and also to prevent cross-contamination.

For the 180 g m⁻² and 210 g m⁻² polyester fabrics, the amount of MPFs released from the one-sided fleece bare fabrics was compared to fabrics coated with the primer-polymer brush coatings following the dry and wet abrasion methods described above.

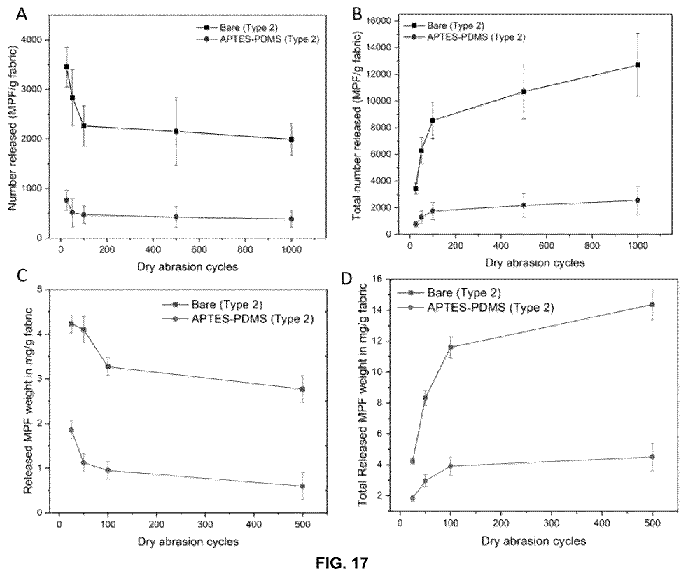

In dry abrasion conditions, the number of MPFs released from bare polyester fabrics (180 g m⁻², one-sided fabric) after 25, 50, 100, 500, and 1,000 abrasion cycles was 3,452±403, 2,835±561, 2,265±410, 2,155±688, and 1,991±332 g⁻¹ fabric, respectively. The release of microfibers gradually decreased while increasing abrasion cycles (FIG. 17A). For the primer-polymer brush coated fabrics, the released amount of MPFs was 767±203, 517±288, 471±178, 425±215, and 387±176 g⁻¹ fabric, respectively, for the same number of abrasion cycles. These reductions were all significant (P values 0.038, 0.043, 0.048, 0.027, and 0.013, respectively) and showed 78%, 82%, 79%, 80%, and 81% reductions compared with bare fabrics (FIG. 17A). The total number of MPFs released from bare and coated fabrics in individual abrasion cycles was calculated and is shown in FIG. 17B. For the bare fabrics, the total MPFs released after 1,000 abrasion cycles was 12,760±2,394 g⁻¹ fabric, whereas the coated fabric released 2,567±1,060 g⁻¹ fabric (FIG. 17B). This significant reduction represented a total 80% reduction compared to the bare fabrics.

The release of MPFs from the 210 g m⁻² double-sided polyester fleece fabric differed from the 180 g m⁻² one-sided fleece fabric. Due to the propensity of the released microfibers to clump together, the released MPFs were weighed using a scale rather than counted for the double-sided polyester fleece fabrics. The amount of MPFs released from the bare double-sided polyester fleece fabrics (210 g m⁻²) in different dry abrasion cycles of 25, 50, 100, and 500 was 4.23±0.2, 4.1 0.3, 3.27 0.2, and 2.77±0.3 mg g⁻¹ fabric, respectively (FIG. 17C). For the primer-polymer brush coated fabrics, the released amount of MPFs was 1.45 0.2, 1.12±0.2, 0.95±0.2, and 0.6±0.3 mg g⁻¹ fabric, respectively. These reductions were significant (P values 0.0032, 0.0023, 0.002, and 0.0013, respectively) and showed 66%, 73%, 71%, and 78% reductions compared with the bare fabrics (FIG. 17C). The total amount of MPFs released after abrasion cycles for the bare and coated fabrics was 14.37±1 mg g⁻¹ fabric and 4.12±0.9 mg g⁻¹ fabric, respectively. This reduction was significant, representing a 71% reduction compared to bare fabrics (FIG. 17D).

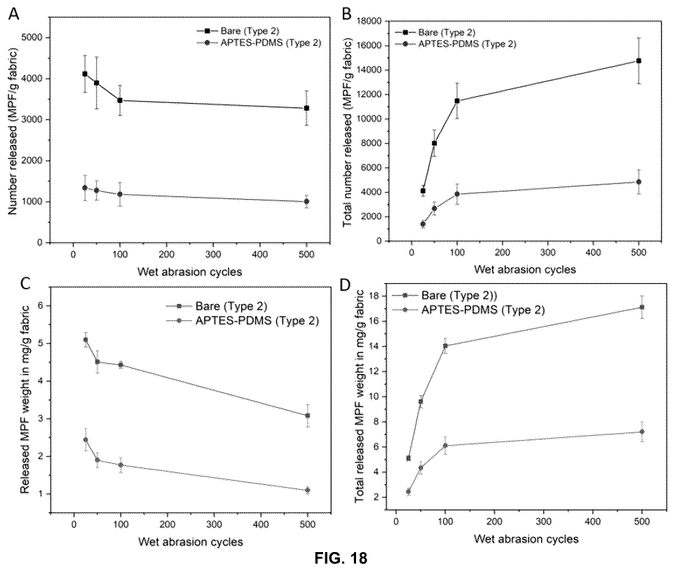

In wet abrasion conditions, the amount of MPFs released from bare polyester fabrics (180 g m⁻²) in different wet abrasion cycles of 25, 50, 100, and 500 was 4,115±450, 3,896±635, 3,470±370, and 3,281±420 g⁻¹ fabric, respectively (FIG. 18A). For the primer-polymer brush coated fabrics, the release of MPFs was 1,339±310, 1,275±238, 1,181±291, and 1,004±157 g⁻¹ fabric, respectively (FIG. 18A). These reductions were significant (P values 0.041, 0.039, 0.037, and 0.046, respectively) and showed 66%, 67%, 66%, and 69% reductions compared with the bare fabrics (FIG. 18A). The total MPFs released from the bare fabric after abrasion cycles was 14,776±1,875 g⁻¹ fabric, whereas the coated fabric released 4,850±996 g⁻¹ fabric (FIG. 18B). This represented a total 67% reduction of microfiber compared to the bare fabrics.

The amount of MPFs released from the bare, double-sided polyester fleece fabrics (210 g m⁻²) in different wet abrasion cycles of 25, 50, 100, and 500 was 5.1±0.2, 4.51±0.3, 4.43±0.1, and 3.08±0.3 mg g⁻¹ fabric, respectively (FIG. 18C). For the primer-polymer brush coated fabrics, the release was 2.04±0.3, 1.9±0.2, 1.77±0.2, and 1.1±0.1 mg g−1 fabric, respectively (FIG. 18C). These reductions were significant (P values 0.0387, 0.0039, 0.041, and 0.039, respectively) and showed 60%, 77%, 60%, and 64% reductions compared with bare fabrics (FIG. 18C). The total amount of MPFs released after 500 abrasion cycles for the bare and coated fabrics was 17.12±0.9 mg g⁻¹ fabric and 6.81±0.8 mg g⁻¹ fabric, respectively. This significant reduction represented a 60% reduction compared to bare fabrics (FIG. 18D).

### Example 6 Study of Waterborne Primer-Polymer Brush

At least for the purpose of being environmentally friendly, it would be desirable that the primer and/or polymer brush are waterborne.

This Example studied APTES as a waterborne primer (WP) 3 and a waterborne polymer brush (WB) 1 using dimethyldimethoxysilane (DMDS) as the monomer for the polymer brush PDMS.

Waterborne Primer WP3: a 1 vol % APTES in water solution was prepared and stirred for one hour at room temperature. The pH was adjusted to 3.8-4.0 using hydrochloric acid (HCI) prior to stirring.

Waterborne polymer brush WB1: a 1.5 vol % solution of dimethyldimethoxysilane in water was prepared, with the pH subsequently adjusted to 3.8-4.0 using HCI. The solution was then mixed for 30 seconds at ambient temperature, prior to application to the fabric swatches.

Waterborne finishing: After cutting circular polyester swatches with a radius of 5 cm, the fabric samples were subjected to oxygen plasma for 2 minutes using a PDC-001-HP Harrick Plasma Cleaner operating at a radio-frequency power setting of 45 W. The samples were then dipped into the WP3 solution for 6 hours at ambient temperature. Following this, the samples were rinsed thoroughly with hexane and isopropanol for 10 min to remove loosely absorbed primer molecules, and then dried in a 75° C. oven for 1 hour. The primer-coated swatches were then again exposed to oxygen plasma for 2 mins at 45 W. Next the samples were immersed in the WB1 solution for 90 minutes on a hotplate held at 150° C. Finally, the samples were taken out, washed with hexane and isopropanol, and dried in an oven for 1 hour at 75° C.

For microfibre washing and counting, the same machine washing technique as shown in FIG. 1 was used. The unfinished polyester shed 1270±180 MPFs after three washes, whereas the polyester finished with the waterborne formulation (WP3/WB1) shed 380±60 MPFs. This represents a 70% reduction in MPF release.

### Example 7 Further Study of Waterborne Primer-Polymer Brush

### Materials

Pristine black 100% PET polyester, one-sided fleece, prefinished fabric (weight of 180 g m⁻²) was received from Arc'teryx. Dimethyldimethoxysilane (DMDS, 95%) was purchased from Gelest. Isopropyl alcohol (IPA, ≥98.5%), hexane (≥98.5%) and toluene (99.9%) were purchased from Fisher Scientific. APTES (99.9%) and Iron (Ill) p-toluenesulfonate hexahydrate (Fe(OTs)₃) were provided by Sigma-Aldrich. Hydrochloric acid (36.5-38%) was supplied by VWR International. DI was used.

### Preparation of Coated Fabric Samples

The polyester samples underwent dual sonication, each lasting for 30 minutes, alternating between isopropanol (IPA) and DI to eliminate potential contaminants. Subsequently, these samples were precision-cut into circular shapes with a 5 cm radius (2 g of each sample) employing a computer-guided CO₂ laser cutter (Glowforge Pro model). Following the cutting process, the samples were subjected to oxygen plasma treatment for 2 minutes using a Harrick Plasma Cleaner (model PDC-001-HP), operating at a radio-frequency power setting of 45 W.

Primer-polymer brush coated fabric samples were prepared in accordance with Scheme 3 below and further described below:

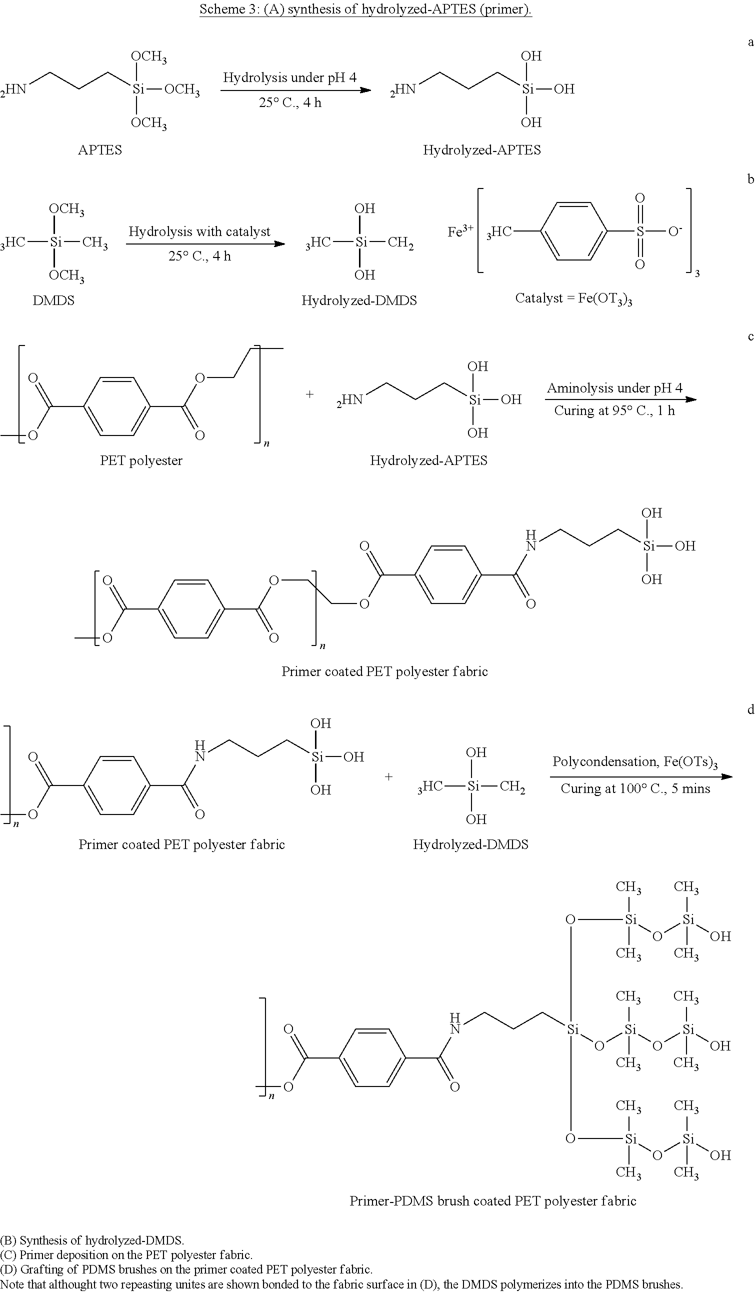

According to Scheme 3, first, the primer was hydrolyzed under pH 4 at 25° C. (see step (A)). The hydrolyzed primer was then bonded to the polyester fabric surface through aminolysis under pH4 followed by curing at elevated temperature (see step (C)). The DMDS was first hydrolyzed in the presence of a Lewis acid catalyst, Fe(OTs)₃ (see step (B)). Lastly, the PDMS brushes were grafted to the surface silanol (Si—OH) groups decorating the primer-coated fabric surfaces via polycondensation in the presence of the catalyst Fe(OTs)₃. The fabric thus coated was cured at elevate temperature (see step (D)). It is postulated that a Lewis acid catalyst such as Fe(OTs)₃ promotes the hydrolysis of the DMDS monomer and also the silanol polycondensation to form the polymer brushes via electrophilic activation of silanol termini while limiting undesirable formation of cyclosiloxane byproducts. Hence, the polymer brushes thus formed can be thick and effective in MPF reductions.

Synthesis of Hydrolyzed APTES Primer: mixing APTES with an aqueous HCI solution (APTES concentration in aqueous HCI solution=1% by volume) for one hour at room temperature. To create the aqueous HCI solution with a pH ranging between 3.8 and 4.0, HCI was mixed with DI.

Preparation of Hydrolyzed DMDS Solution: DMDS and Fe(OTs)₃ were combined in ACS-grade water (molar ratio of DMDS: Fe(OTs)₃: H₂O=0.30:2×10⁻⁶:1). The mixture was stirred for 30 seconds at room temperature, then allowed to sit for 3 minutes to allow the DMDS to completely dissolve in water. The hydrolyzed DMDS solution remained stable for approximately 2 hours before any precipitation or inhomogeneity was observed. To prevent DMDS from spontaneous reacting upon hydrolysis, as evidenced by precipitation or inhomogeneity, it is preferred that the hydrolyzed DMDS solution be applied promptly.

Deposition of APTES primer on Polyester Fabric: the fabric samples were dipped into the solution containing the hydrolyzed APTES with a 1:100 (wt/v %) fabric: primer solution ratio for 6 hr at ambient temperature. Following the immersion, the samples were rinsed thoroughly with hexane and IPA for 10 mins to remove any non-bonded APTES molecules and were subsequently dried at about 95° C. for 1 hr in an oven.

Deposition of Waterborne PDMS Brushes: The polyester fabric samples coated with the primer were exposed to oxygen plasma for 2 mins at 45 W to ensure that any remaining methoxy or ethoxy groups on the surface were converted to silanols. Then, the hydrolyzed DMDS solution was applied to the samples through spray coating. A total of 3 sprays of the hydrolyzed DMDS solution were applied to each sample at 0.075 L/m² using a power sprayer positioned 30 cm away from the sample. In between each spray, the sample was cured at 100° C. for 5 min. After the third spray and curing, the sample was rinsed with hexane and IPA to remove any unreacted molecules and then dried at 100° C. for an additional 10 min. The thickness of the PDMS brushes were measured using a Film Sense FS-8 ellipsometer with an incident angle of 70°. The refractive index n and extinction coefficient k were measured at 8 wavelengths of incident light, from 370 to 950 nm, which were used to fit a Cauchy model for transparent materials (Si—SiO₂-PDMS), from which the thickness of the layers could be obtained.

The molecular weight of a polymer brush, such as PDMS brush, can be estimated from thickness and grafting density using the following equation:

$$Mw = \frac{h \times {N}_{A}}{σ \times d}$$

wherein h is thickness of the polymer brush (cm); N_{A} is Avogadro's number (6.022×10²³); σ is grafting density (chains per cm²) and assumed to be 0.2 chain/nm²; and d is the density of the polymer brush (in the case of PDMS: approximately 0.965 g/cm³).

The above equation assumes that the polymer brushes are densely packed and stretched due to their grafting density.

Table 3 below provides ellipsometry measurements of PDMS coating thickness on a smooth silicon (Si) wafer, along with estimated molecular weight values derived from the thickness data using the above equation. Measuring the polymer coating thickness on a Si wafter provides a reasonable approximation of the thickness of polymer brushes on a coated fabric, as the same reaction conditions were used to prepare the PDMS coating on the Si wafer and the thickness of the coatings on wafers and fabrics does not vary significantly.

TABLE 3
Thickness and Molecular Weight of PDMS Brushes

| Catalyst | HCl (Example 6) | Fe (OTs)₃ (Example 7) |
|---|---|---|
| Coating Thickness | 1.52 ± 0.23 nm | 3.18 ± 0.14 nm |
| Estimated MW | 4743 ± 718 | 9922 ± 437 |

Results. The uncoated and coated fabrics were washed for a total of five times, with each wash performed at 60° C. for 1 hr. After washing, MPFs were counted in accordance with the counting method described in Example 1 and additionally analyzed using the total mass released. Based on the amount of MPFs released, the waterborne primer-polymer brush coating (WP3/WB1 in this example) reduced MPF release by more than 79% after the five washing cycles. Based on the total mass of MPFs released after the five washing cycles, the coating's efficacy was greater than 86% reduction in MPFs.

While the present invention has been described with reference to specific embodiments and examples, it is to be understood that the invention is not limited to the disclosed examples. To the contrary, the present disclosure is intended to cover various modifications and equivalent arrangements. The present disclosure is further intended to cover the application of various alternatives described in respect of one embodiment with other embodiments where it is suitable to do so. Such modifications and arrangements are included within the spirit and scope of the appended claims.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

What is claimed is:

1. A textile coating composition comprising:
a primer bonding to at least one surface of a textile, wherein the primer is of general formula (I) 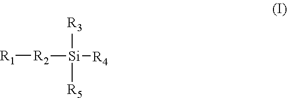
wherein R₁ forms a bond with the at least one surface and is selected from the group consisting of amine, alkoxy, hydroxy, acid, acrylate, halide, ester, ether, alcohol, vinyl, carboxylic, carbonyl, amino, and mercapto;
R₂ is selected from the group consisting of alkyl, aryl, siloxane and any combinations thereof; and
R₃, R₄ and R₅ are each independently hydroxy, alkoxy optionally substituted with an alkoxy, siloxy, halide or alkyl, with the proviso that R₃, R₄ and R₅ are not simultaneously alkyl; and
a polymer brush forming a bond with at least one of R₃, R₄ and R₅ of the primer, wherein the polymer brush comprises a polymer having an oxygen-containing backbone and having a glass transition temperature less than about 20° C.

2. The textile coating composition of claim 1, wherein R₁ is an acid, mercapto, amino or vinyl.

3. The textile coating composition of claim 1, wherein R₃, R₄ and R₅ are simultaneously of the same hydroxy, alkoxy optionally substituted with an alkoxy, siloxy, or halide.

4. The textile coating composition of claim 1, wherein the primer is 3-mercaptopropyltrimethoxysilane, 3-mercaptopropyltrichlorosilane, 3-mercaptopropyltriethoxysilane, 3-mercaptopropyldimethylmethoxysilane, 3-mercaptopropyldimethylethoxysilane, 3-mercaptopropyldimethylchlorosilane, 3-mercaptopropyldichloromethylsilane, (3-aminopropyl) triethoxysilane, (3-aminopropyl) trimethoxysilane, (3-aminopropyl) dimethylethoxysilane, (3-aminopropyl) dimethylmethoxy silane, (3-aminopropyl) trichlorosilane, (3-aminopropyl) dichloromethylsilane, (3-aminopropyl) dimethoxymethylsilane, trimethyl (vinyl) silane, vinyltris (2-methoxyethoxy) silane, methyl bis(trimethylsilyloxy) vinylsilane, or tris (trimethylsiloxy) (vinyl) silane.

5. The textile coating composition of claim 1, wherein the polymer brush is of general formula (II) 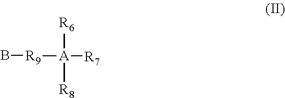
wherein A is Si or C;
B is the polymer and is selected from the group consisting of poly(dimethylsiloxane), poly(ethylene glycol), polytetrahydrofuran, polyoxetane, pluronic, polyglycerol, polypropyleneglycol, polytetramethylene ether glycol, polybutylene oxide glycol, polypropylene oxide glycol, polidocanol, poly(p-phenylene oxide), perfluoropolyether, polydioxanone and polysiloxane;
R₆, R₇ and R₈ are each independently halide, alkoxy, hydroxy or alkyl, with the proviso that at least one of R₆, R₇ and R₈ is halide, alkoxy or hydroxy to form a bond with at least one of R₃, R₄ and R₅, when the at least one of R₃, R₄ and R₅ is not alkyl; and
R₉ is absent or when present, R₉ is a linker comprising at least C1 and is not a repeating unit of the polymer.

6. The textile coating composition of claim 5, wherein R₇ is hydroxy, halide or alkoxy and forms a bond with each of R₃, R₄ and R₅ when R₃, R₄ and R₅ are all hydroxy.

7. The textile coating composition of claim 1, wherein the polymer is poly(ethylene glycol), perfluoropolyether or poly(dimethylsiloxane).

8. The textile coating composition of claim 1, wherein the polymer has a molecular weight of about 500 to about 100,000.

9. The textile coating composition of claim 1, wherein the polymer is prepared by a silanol polycondensation of a siloxane, silane or silyl ether functionalized monomer in the presence of a Lewis acid catalyst; wherein the monomer is optionally hydrolyzed in the presence of the Lewis acid catalyst.

10. A coated textile comprising:
a textile;
a primer layer bonding to at least one surface of the textile, wherein the primer layer comprises a primer of general formula (I) 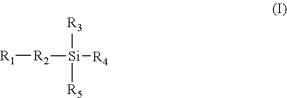
wherein R₁ forms a bond with the at least one surface and is selected from the group consisting of amine, alkoxy, hydroxy, acid, acrylate, halide, ester, ether, alcohol, vinyl, carboxylic, carbonyl, amino, and mercapto;
R₂ is selected from the group consisting of alkyl, aryl, siloxane and any combinations thereof; and
R₃, R₄ and R₅ are each independently hydroxy, alkoxy optionally substituted with an alkoxy, siloxy, halide, or alkyl, with the proviso that R₃, R₄ and R₅ are not simultaneously alkyl; and
a polymer brush layer overlaying the primer layer, wherein the polymer brush layer comprises a polymer brush forming a bond with at least one of R₃, R₄ and R₅ of the primer, wherein the polymer brush comprises a polymer having an oxygen-containing backbone and having a glass transition temperature less than about 20° C.

11. The coated textile of claim 10, wherein R₁ is an acid, mercapto, amino or vinyl.

12. The coated textile of claim 10, wherein the primer is 3-mercaptopropyltrimethoxysilane, 3-mercaptopropyltrichlorosilane, 3-mercaptopropyltriethoxysilane, 3-mercaptopropyldimethylmethoxysilane, 3-mercaptopropyldimethylethoxysilane, 3-mercaptopropyldimethylchlorosilane, 3-mercaptopropyldichloromethylsilane, (3-aminopropyl) triethoxysilane, (3-aminopropyl) trimethoxysilane, (3-aminopropyl) dimethylethoxysilane, (3-aminopropyl) dimethylmethoxy silane, (3-aminopropyl) trichlorosilane, (3-aminopropyl) dichloromethylsilane, (3-aminopropyl) dimethoxymethylsilane, trimethyl (vinyl) silane, vinyl tris(2-methoxyethoxy) silane, methyl bis(trimethylsilyloxy) vinylsilane, or tris(trimethylsiloxy) (vinyl) silane.

13. The coated textile of claim 10, wherein the polymer brush is of general formula (II) 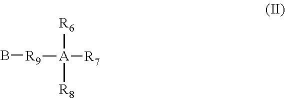
wherein A is Si or C;
B is the polymer and is selected from the group consisting of poly(dimethylsiloxane), poly(ethylene glycol), polytetrahydrofuran, polyoxetane, pluronic, polyglycerol, polypropyleneglycol, polytetramethylene ether glycol, polybutylene oxide glycol, polypropylene oxide glycol, polidocanol, poly(p-phenylene oxide), perfluoropolyether, polydioxanone and polysiloxane;
R₆, R₇ and R₈ are each independently halide, alkoxy, hydroxy or alkyl, with the proviso that at least one of R₆, R₇ and R₈ is halide, alkoxy or hydroxy to form a bond with at least one of R₃, R₄ and R₅, when the at least one of R₃, R₄ and R₅ is not alkyl; and
R₉ is absent or when present, R₉ is a linker comprising at least C1 and is not a repeating unit of the polymer.

14. The coated textile of claim 10, wherein the polymer is poly(ethylene glycol), perfluoropolyether or poly(dimethylsiloxane).

15. The coated textile of claim 10, wherein the polymer has a molecular weight of about 500 to about 100,000.

16. The coated textile of claim 10, wherein the coated textile exhibits a friction coefficient of less than about 0.35.

17. The coated textile of claim 10, wherein the textile is nylon, polyester, acetate, acrylic, spandex, polyolefin, polyaramid, polyethylene, polypropylene, cotton, jute, hemp, bamboo, linen, wool, rayon, silk or any combinations thereof.

18. A method of forming a coated textile, comprising:
depositing a primer layer on a surface of a textile to form a textile surface coated with the primer layer, wherein the primer layer comprises a primer of general formula (I) 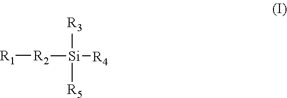
wherein R₁ forms a bond with the at least one surface and is selected from the group consisting of amine, alkoxy, hydroxy, acid, acrylate, halide, ester, ether, alcohol, vinyl, carboxylic, carbonyl, amino, and mercapto;
R₂ is selected from the group consisting of alkyl, aryl, siloxane and any combinations thereof; and
R₃, R₄ and R₅ are each independently hydroxy, alkoxy optionally substituted with an alkoxy, siloxy, halide, or alkyl, with the proviso that R₃, R₄ and R₅ are not simultaneously alkyl;
and
depositing a polymer brush layer on the textile surface coated with the primer layer to form the coated textile, wherein the polymer brush layer comprises a polymer brush forming a bond with at least one of R₃, R₄ and R₅ of the primer, wherein the polymer brush comprises a polymer having an oxygen-containing backbone and having a glass transition temperature less than about 20° C.;
wherein the coated textile exhibits a friction coefficient of less than about 0.35.

19. The method of claim 18, wherein the polymer brush is of general formula (II) 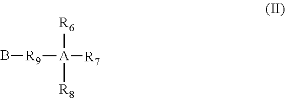
wherein A is Si or C;
B is the polymer and is selected from the group consisting of poly(dimethylsiloxane), poly(ethylene glycol), polytetrahydrofuran, polyoxetane, pluronic, polyglycerol, polypropyleneglycol, polytetramethylene ether glycol, polybutylene oxide glycol, polypropylene oxide glycol, polidocanol, poly(p-phenylene oxide), perfluoropolyether, polydioxanone and polysiloxane;
R₆, R₇ and R₈ are each independently halide, alkoxy, hydroxy or alkyl, with the proviso that at least one of R₆, R₇ and R₈ is halide, alkoxy or hydroxy to form a bond with at least one of R₃, R₄ and R₅, when the at least one of R₃, R₄ and R₅ is not alkyl; and
R₉ is absent or when present, R₉ is a linker comprising at least C1 and is not a repeating unit of the polymer.

20. The method of claim 18, wherein the primer layer is deposited onto the at least one surface by dipping, padding, spraying, drawing, using an applicator in a gaseous phase, spinning, or using a plasma; and the polymer brush layer is deposited onto the textile surface coated with the primer layer by dipping, padding, spraying, drawing, using an applicator in a gaseous phase, spinning, or using a plasma.
